(19) United States
(12) Patent Application Publication
(10) Pub. No.: US 2008/0072234 A1
(43) Pub. Date: Mar. 20, 2008

(54) Method and apparatus for executing commands from a drawing/graphics editor using task interaction pattern recognition

(76) Inventor: Gerald Myroup, Schererville, IN (US)

Correspondence Address: ICE MILLER LLP, ONE AMERICAN SQUARE, SUITE 3100, INDIANAPOLIS, IN, 46282-0200, US

(21) Appl. No.: 11/900,057

(22) Filed: Sep. 10, 2007

Related U.S. Application Data
(60) Provisional application No. 60/846,015, filed on Sep. 20, 2006.

(51) Int. Cl. G06F 9/46

(52) U.S. Cl. 718/106

(57) ABSTRACT

A system and method for generating graphical images and drawing images utilizing a drawing editor having a plurality of functions that manipulate data from which the screen display is generated is disclosed. A plurality of task modes are designated and each function that manipulates data is associated with one of the designated task modes, a mode invocation method is designated for invoking each of the plurality of task modes and task mode sensitive distinct interaction pattern is associated with each function.

### RELATED APPLICATIONS

This application claims the benefit of co-pending U.S. Provisional Application 60/846,015 filed Sep. 20, 2006, the disclosure of which is hereby incorporated herein by this reference.

### BACKGROUND OF THE INVENTION

This disclosure relates generally to computer drawing programs that allow a user to create drawings, sketches and images, and, more particularly, to computer aided drawing programs wherein multiple different drawing tools are utilized to create and modify drawings, sketches and images.

The advent and popularity of graphical user interfaces, such as those found with Apple Computer operating systems and the Microsoft Corporation's Windows® operating systems, was thought to be far superior to that of text based operating systems, such as DOS or Unix. In many respects, a graphical user interface (“GUI”) is preferred. When GUIs were first introduced, computer users felt that the GUI made them work slower since it was faster to simply type the command rather then selecting it with a mouse. Thus, the Command Line feature in programs such as Autocad is still very popular, even though users must memorize keystroke patterns in order to be productive. With a GUI, operating system functions, such as creation of a folder, copying files, moving files, and the like, are intuitive as these functions lend themselves very well to a graphical depiction of the function. However, such a graphical depiction is not always useful for operation of other software functions. Thus, to access the functions of the software, most GUIs utilize one or more menus or toolbars from which pull-down submenus or additional toolbars may be accessed. With such a GUI, a user need not memorize commands to invoke functions provided by the software. Instead, the user may usually find functions from pull-down menus or toolbars that are usually provided along the top of a GUI screen.

However, in many instances a GUI can be frustrating for a user to operate. Such frustration may be rooted in a user's need to access many such functions repetitively. For example, a user may “copy”, “cut”, and “paste” often. If the user is required to use pull-down menus for each “copy”, “cut”, and “paste” operation, the user can be frustrated by the amount of time required to repetitively pull down the menu where the “copy”, “cut”, and “paste” functions are accessible. In addition, it is not uncommon for most functions of a software program using a GUI to be accessible only through a pull-down, pop-up or other menu. This means users must continually make selections using the menus. Users of GUI based programs would appreciate an interface that avoids these frustrations, i.e. does not require them to continually access the menu for common functions of the software program.

One common solution to the inefficiency issues related with pull-down, pop-up or other menus is the development of what is generally known as a “shortcut”. A shortcut is a series of keystrokes that invoke a function of the software program. For example, when using Microsoft Corporation products in the Windows® environment, <CTRL>c is usually the shortcut for “copy”, <CTRL>x is usually the shortcut for “cut”, and <CTRL>v is usually the shortcut for “paste”. Similarly, in Apple Computer's operating systems, software programs usually use <COMMAND>c as the shortcut for “copy”, <COMMAND>x as the shortcut for “cut”, and <COMMAND>v as the shortcut for “paste”. Such shortcuts are particularly useful for a regular user of the software. Although the use of shortcuts requires memorization of the shortcut by the user, the requirement for such memorization is usually not an issue for regular users as the shortcuts save substantial time when using the program.

While shortcuts can improve efficiency of document or graphics generation, they also have limitations. First, shortcuts have generally only been developed for functions that are found in a plurality of different software functions, such as the copy, cut, and paste functions discussed herein. Also, shortcuts are not usually organized into groupings of like functions so they are intuitive in the memorization process. A user interface that utilizes an intuitive approach so that a plurality of functions of the software can be simply accessed would be appreciated by users of such software.

Past and current Computer Aided Drawing and Drafting (“CAD/D”) and drawing/graphics editors present the user with a common, highly familiar user-interface for creating geometric objects. Almost all of these editors utilize a traditional hierarchal menu structure, context sensitive menus, toolbars, shortcut keys, and command line input. The depth and complexity of menu options and toolbars varies greatly from one editor to another. More importantly, the user must continually navigate these menus, toolbars, and shortcut keys hundreds of times during the course of a typical workday. Depending on the drawing/graphics editor, users may be required to drill down two or three menu levels in order to perform even the simplest task.

The hierarchal menu systems present in these editors allow novice or part-time users to create and alter geometric objects without having to learn and remember how to use the editor. While menus are of great value to these users, they are highly counter-productive for the trained, more seasoned “power user”, i.e. those spending a considerable portion of their workday using a drawing system.

Currently, users requiring a higher degree of productivity often utilize the command line and/or toolbars. While more productive than navigating menus, these interfaces leave room for improvement. Like menus, command line instructions and toolbars still require the user to divert their attention away from the design and drawing process in order to select a toolbar option or enter an abbreviated command. While requiring fewer steps to perform a task, this unproductive interaction still occurs hundreds of times a day. While today's computerized drawing/graphics editors produce results much faster than drawing “on the board”, users still need to change drawing tools via menu or toolbar selections or shortcut keypresses.

### SUMMARY OF THE INVENTION

The disclosed user interface and method reduce the interaction required to create and manipulate geometric objects to be displayed on a monitor. The disclosed user interface and method do not require hierarchical and context sensitive menu systems, and are not dependent upon the use of toolbars or shortcut keys or the need to enter a significant number of commands to perform common functions of a program. Nevertheless, the disclosed user interface and method may be used in combination with a traditional GUI having hierarchical and context sensitive menu systems, toolbars, shortcut keys, and/or the need to enter commands within the scope of the disclosure.

In general, in implementing the disclosed interface and method, the functions of the software program are categorized into a reasonable number of task modes. Once the task modes and functions that belong to each of the task modes have been identified, a mode invocation method (such as a single or multi-keypress or command button click) is defined in order to activate each of the task modes. Additionally, distinct user/computer interaction patterns comprising mouse or other pointer device operations are defined in order to execute each command of the software accessible in that task mode.

During operation, to execute a desired command of the software program, the user activates, via the mode invocation method, the task mode associated with the command they wish to execute and then performs the distinct interaction pattern corresponding to the command they wish to execute. In one embodiment, activating a task mode is only required when the desired command does not belong to the task mode in which the user is currently working in. The utilization of the disclosed user interface saves significant time in operation of the software program once a user commits the task mode invocation method and interaction patterns associated with commonly used commands to memory. In one disclosed embodiment, the efficiency of operation of the user interface is improved by pre-designating the software commands associated with a particular mode in a manner whereby such commands are logically associated with each other. Among the methods for logically associating software commands with a mode is to associate commands that are of the same type (e.g. group all software commands that create objects) with a particular task mode.

According to one aspect of the disclosure, an apparatus for executing commands from a graphics editor comprises a computer system and graphics editor software. The computer system includes a bus for communicating information, a processor coupled with the bus for processing information, memory coupled to the bus for storing information and instructions for the processor, a display device coupled to the bus for displaying information to the computer user, a cursor, an alpha-numeric input device including alpha numeric and other keys coupled to the bus, and a cursor control device for communicating direction information and command selections to the processor and for controlling the cursor movement. The graphic editor software is resident in the memory. The graphic editor software has software commands for generating and manipulating objects represented by addressable data structures stored in memory from which the processor generates video output for generating a graphical display of the object on the display device. The software includes user selectable task modes with which each of the plurality of software commands is associated, each software command being executed upon entry of an interaction pattern including cursor control device gestures input while the cursor is in the graphics window while the program is in the task mode with which the software command is associated.

According to another aspect of the disclosure, a method of rendering a graphical image in a computer controlled video display system is provided. The method includes providing a program for generating graphical images in a graphics window of a computer controlled video display in response to a plurality of software commands that generate video output and defining a plurality of task modes to be implemented by the program. The method further comprises designating a predefined mode activation method for each of the plurality of task modes whereby upon performing of one of the predefined mode activation methods the task mode with which the predefined mode activation method is designated is implemented by the program. Each of the plurality of software commands is associated with one of the plurality of task modes and a predefined user input is designated to act as mode dependent task identifier for executing the software commands of the provided program. Each predefined user input includes pointer device gestures input while the cursor is in the graphics window. The method includes monitoring the output of the alpha-numeric device and pointer device to determine if the output of those devices corresponds to a predefined alpha-numeric input and a predefined user input. One of the plurality of software commands is executed when the monitoring step determines that the output corresponds with the program implementing the task mode with which the software command is associated and the mode dependent task identifier designated for the software command.

Additional features and advantages of the invention will become apparent to those skilled in the art upon consideration of the following detailed description of a preferred embodiment exemplifying the best mode of carrying out the invention as presently perceived.

### BRIEF DESCRIPTION OF THE DRAWINGS

The present invention is illustrated by way of example and not limitation in the figures of the accompanying drawings in which like references indicate similar elements and in which:

FIG. 1 is a block diagram of a computer system that is used in a preferred embodiment;

FIG. 2 is a block diagram of the method for executing commands from a drawings/graphics editor;

FIG. 3 is a flow diagram of the implementation of the method of FIG. 2 in a specific software environment to create a line;

FIG. 4 is a flow diagram of the implementation of the method of FIG. 2 in a specific software environment to extend a line to an object;

FIG. 5 is a flow diagram of the implementation of the method of FIG. 2 in a specific software environment to generate a copy of a circle at a first location in a second location;

FIG. 6 is a flow diagram of a monitoring step of identifying mouse gestures of the disclosed method of executing commands from a drawings/graphics editor using task pattern recognition;

FIG. 7 is a flow diagram of setting the values of the Interaction Details Array that are associated with the mouse down event of FIG. 6;

FIG. 8 is a flow diagram of setting the values of the Interaction Details Array that are associated with the mouse down up event of FIG. 6;

FIG. 9 is a flow diagram of the Evaluate Drag Action step of the monitoring step of FIG. 6;

FIG. 10 is a flow diagram of the Task Interaction Pattern Recognition process; and

FIG. 11 is a flow diagram of portions of the Task Interaction Pattern Recognition process when implemented utilizing a mouse gesture.

### DETAILED DESCRIPTION

While the description of the disclosed device, user interface and method refers to mouse operations, those skilled in the art will recognize that similar operations can be performed with other input devices, such as touch sensitive screens and pads, trackballs, keyboard keys and the like. Thus, where appropriate, the term mouse operations should be interpreted as including operations with other input devices.

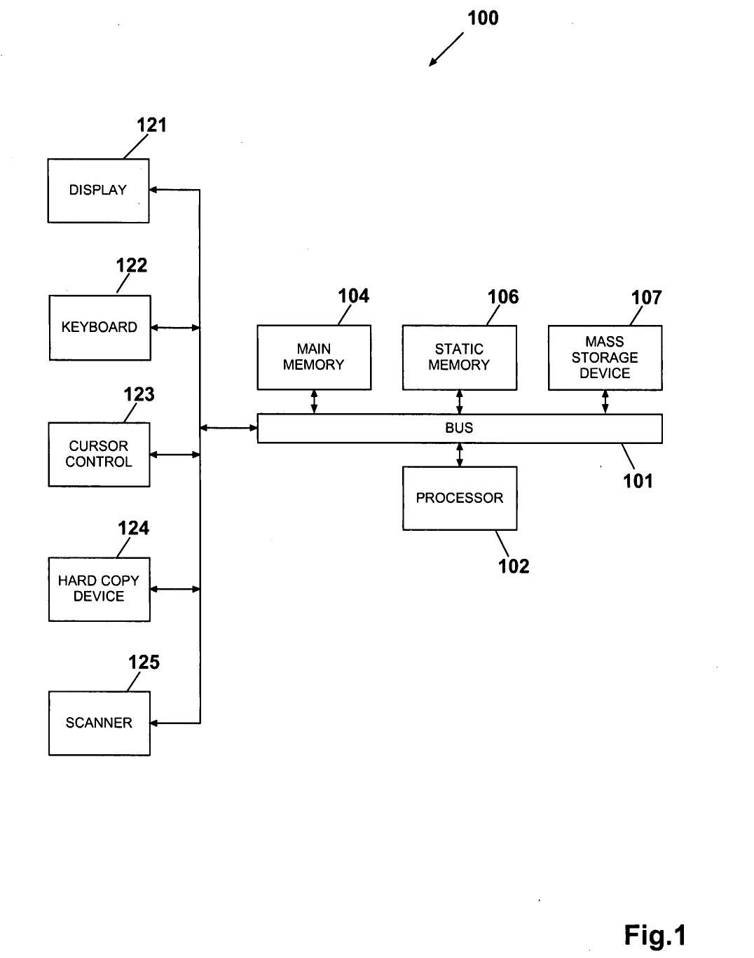

FIG. 1 illustrates computer system 100 upon which a preferred embodiment of the present invention is implemented. Computer system 100 comprises a bus or other communication means 101 for communicating information, a processing means 102 coupled with bus 101 for processing information, and a random access memory (RAM) or other dynamic storage device 104 (commonly referred to as main memory) coupled to bus 101 for storing information and instructions for processor 102. Computer system 100 also comprises a read only memory (ROM) or other static storage device 106 coupled to bus 101 for storing static information and instructions for the processor 102, a data storage device 107, such as a magnetic disk or optical disk and disk drive, coupled to bus 101 for storing information and instructions. Computer system 100 further comprises a display device 121 or monitor, such as a cathode ray tube (“CRT”) an LED or plasma flat screen display or the like, coupled to bus 101 for displaying information to the computer user, an alpha-numeric input device 122, including alpha numeric and other keys, coupled to bus 101 for communicating information and command selections to processor 102, and a cursor control device 123, such as a mouse, a track ball, cursor direction keys or other pointer device, coupled to bus 101 for communicating direction information and command selections to processor 102 and for controlling the cursor movement. It is also useful if the system includes a hard copy device 124, such as a printer, for providing permanent copies of information on paper, film, or other physical media with which the user can visually examine information. The hard copy device 124 is coupled to the processor 102, main memory 104, static memory 106, and mass storage device 107 through bus 101. Finally, it is useful if a scanner 125 is coupled to bus 101 for digitizing graphic images.

The disclosed user interface for software program environments preferably utilizes an intuitive approach for performing the software program's functions. In one embodiment, the disclosed user interface does not require a hierarchical and context sensitive menu system, and is not dependent upon the use of toolbars, shortcut keys, or the need to enter a significant number of commands. However, the disclosed interface may be used in combination with a traditional GUI having a hierarchical and context sensitive menu system, toolbars, shortcut keys, and/or the need to enter commands within the scope of the disclosure.

The disclosed user interface is particularly applicable for utilization with a drawing or CAD editor having defined functions for operations on primitives (lines, arcs, etc.) utilized by the program to provide a graphical representation on a monitor 121. Such drawing or CAD editor programs typically store the primitives utilized to form the graphics to be displayed on the monitor 121 as objects in a data structure in memory 104. The operations performed on the objects, or the primitives forming the objects, typically alter the data stored in the data structure, by for example altering the value stored at a memory address referenced by a pointer in one of the fields of the data structure. The data stored in the data structure is utilized to generate the graphics displayed on the monitor 121. The disclosed system 100, user interface and method associates functions available in the software program with combinations of user inputs to modify the data in the data structures and thereby alter the displayed graphics.

The disclosed user interface presents the user with a drawing/graphics editor wherein the user can avoid or reduce the dependency on hierarchal and context sensitive menu systems, toolbars, shortcut keys, and the need to enter commands via a command line when creating drawings. In one embodiment, the disclosed user interface and method utilize Task Modes, Task Interaction Pattern Recognition (TIPR) and Advanced Mouse Techniques in order to overcome productivity limits imposed by interaction techniques of modem day drawing/graphics editors. Each of these will be described in greater detail below to facilitate understanding of the disclosed user interface and method.

Task Modes are one aspect of the disclosed user interface and method. Task modes define (in very general terms) what operations the user can perform while in a particular mode. The number of Task Modes required depends on the logical grouping of similar operations by the software designer. In one embodiment, in which the disclosed interface is implemented to facilitate generating graphics as an Add-In/On for AutoCAD® software, the task modes have been identified as Creation, Alteration, Transformation, Annotation, and Inquiry modes.

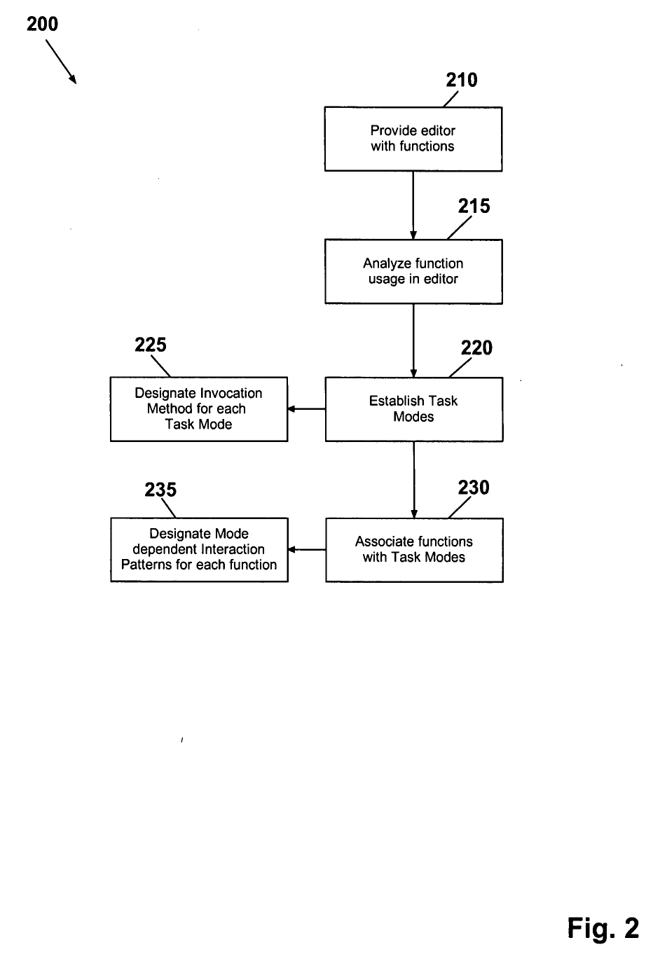

As shown for example in FIG. 2, the method 200 of executing commands in a graphics/drawing editor includes the step 210 of providing a graphics/drawing editor having functions for generating data from which a video output can be generated for displaying images on a monitor 121. In accordance with the disclosure, the functions of the software program are categorized into a reasonable number of task modes. Thus, a plurality of task modes are established 220 and functions are associated with the plurality of task modes 230. While the disclosure envisions that each of the graphics data generating functions of the software are associated with an appropriate one of the task modes, it is within the scope of the disclosure for all of the functions of the software to be associated with an appropriate task mode, for only commonly accessed functions of the software to be associated with appropriate task modes or some other limitation to be implemented on the number of available software functions that are associated with appropriate task modes.

Preferably, the software functions associated with and executable from within a task mode are of the type to be logically grouped together. One form of logical grouping for functions within a task mode is to associate functions within a mode that perform similar functions. Thus prior to establishing the number and names of the task modes to be created, the operation of the provided software is analyzed 215 to determine the manner in which functions of the software are typically utilized. This analysis provides a basis for establishing how many task modes should be created and which functions should be associated with each of the task modes. For example, in a drawing or CAD editor, analysis indicates that a user typically creates an initial drawing by creating a number of primitives or blocks that approximately represent the desired display. Thus, the functions for creating primitives and blocks are typically considered to perform similar functions by the user of such a software program. Therefore, in one embodiment, functions that create primitives in a drawing or CAD editor are associated with a particular task mode. This task mode in one embodiment is identified and referred to as a Creation task mode. Once the initial drawing is created, users of drawing and CAD editors, typically modify or alter the created primitives or blocks to more accurately reflect the desired graphical representation, move primitives or blocks around within the drawings and annotate the drawings. Separate task modes may be identified for each of these broad categories into which functions required to carry out the operations are grouped.

Once the number of desired task modes has been determined and a plurality of task modes have been established a unique mode invocation method is established 225 for each task mode by which the task mode with which it is associated may be invoked. Preferably, each mode invocation method is a simple user action. In one embodiment, the simple action is pressing a key on the keyboard 122 of the computer system 100.

A distinct task mode dependent interaction pattern is established 235 for each of the functions that were associated with a task mode 230. When these interaction patterns are performed while in the task mode with which the function is associated, the associated function is executed by the software. The task mode dependent interaction pattern in one embodiment is carried out using primarily mouse operations while in a task mode. The task mode interaction pattern includes not only mouse gestures, but also may include the locations at which the mouse gestures are performed, the objects the cursor is on or passes over when the mouse gestures are executed and type of and location on the object the cursor is over when the mouse gesture is executed. In one embodiment, the mouse gestures include the traditional left-click, right-click, double-click, and click and drag operations, as well as more advanced mouse action techniques such as ClicknPause, ClicknPauseDrag, ClicknHold, DoubleClicknPause, DoubleClicknDrag, ClicknDragPause and DoubleClicknPauseDrag or combinations thereof.

During operation, to perform a function of the software program, the user executes the task mode invocation method for the task mode with which the desired function was associated, and then performs the interaction pattern corresponding to the desired function. Functions associated with a particular task mode may be of the type that are logically associated with each other to facilitate familiarization of the user with the interface.

Those skilled in the art will recognize that the number of functions available in drawing editor programs may be so great that if only common or standard mouse gestures (i.e. left-click, right-click, doubleclick, click and drag) are utilized the number of task modes required in order for all of the commonly used functions to be executed utilizing a distinct task mode and a distinct interaction pattern combination would become unwieldy. Thus, the disclosed device, interface and method contemplate utilizing combinations of standard mouse gestures and/or advanced mouse gestures during the execution of the selected interaction patterns. Among the advanced mouse gestures envisioned to be utilized with the disclosed interface and method are ClicknPause, ClicknPauseDrag, ClicknHold, DoubleClicknPause, DoubleClicknDrag, ClicknDragPause and DoubleClicknPauseDrag mouse gestures. Any of these gestures can be performed utilizing either the primary (typically left) mouse button or the secondary (typically right) mouse button with each gesture generating a different output when performed with the primary mouse button than the same gesture generates when performed with the secondary mouse button. Additionally, when the system includes a three button mouse, each of these gestures can also be performed with the middle mouse button/scroll wheel.

The ClicknPause mouse gesture involves the user holding the mouse button down a moment longer than normal before releasing the mouse button. In one specific embodiment, a tool tip displaying the word “Release” appears, signaling the user to release the mouse button. The ClicknPauseDrag gesture involves the user pressing the mouse button a moment longer than normal before dragging to a new screen position and releasing the mouse button. The ClicknHold gesture involves the user holding the mouse button down for an extended duration (e.g. approx 1 second) before releasing the mouse button. In one specific embodiment, a slightly larger tool tip displaying the word “Release” appears, signaling the user to release the mouse button. The DoubleClicknPause gesture involves the user holding the mouse button down a moment longer than normal on the second click before releasing the mouse button. The DoubleClicknDrag gesture involves the user performing a double-click action dragging after the second click to a new screen position and releasing the mouse button. The ClicknDragPause gesture involves the user pausing a brief moment before releasing the mouse button after dragging to the desired location. The DoubleClicknPauseDrag gesture involves the user performing a double-click action, pausing a moment after the second click and dragging to a new screen position before releasing the mouse button. In one specific embodiment, a tool tip displaying the word “Release” appears signaling the user to release the mouse button.

In order to execute functions of the software program the system continually monitors all interaction between the user and any attached input devices while in a task mode. Methods of identifying user to computer interaction are known in the art and may be implemented in any of the known manners or in some unique manner generated by an insightful programmer. Methods of identifying mouse and other pointing device gestures are disclosed in U.S. Pat. Nos. 5,182,548; 6,668,081, and in standard programming language texts.

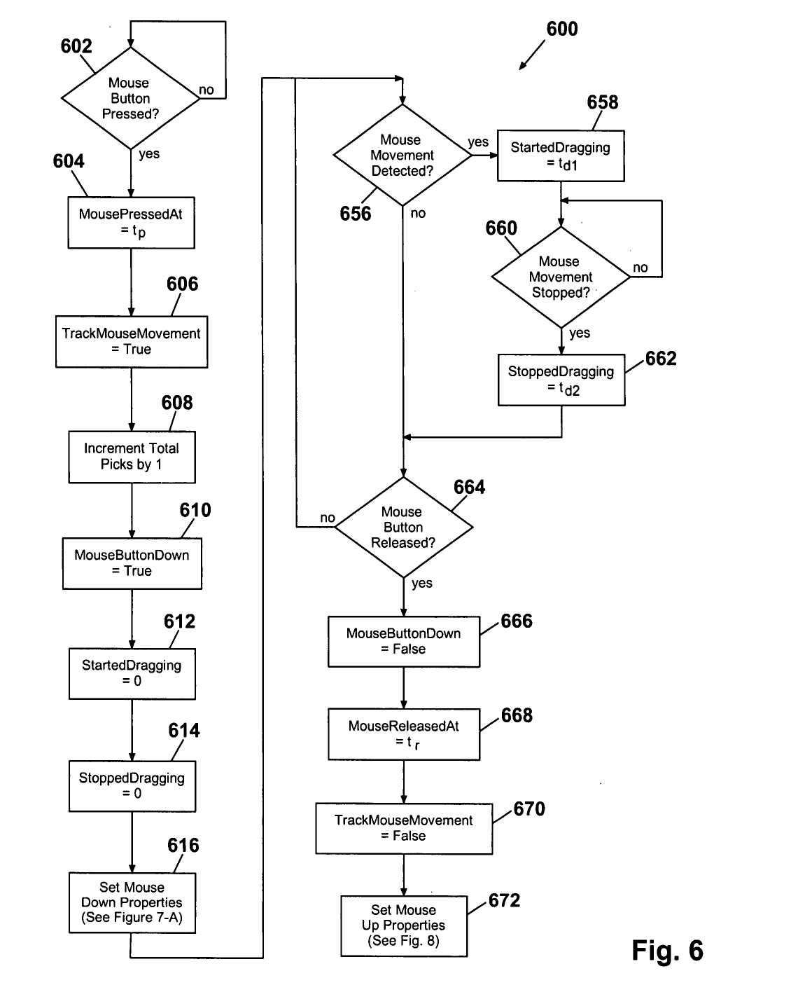

In one specific embodiment, mouse gestures are identified by monitoring which button of the pointing device was pressed, if the pointing device was moved from the time the button was pressed to the time it was released, where the device moved from and to, how long the button was pressed before moving the device and how long after the user stopped moving the device until the button was released. As shown, for example, in FIG. 6, this monitoring step 600 includes multiple steps. Using a monitoring technique more commonly known to one skilled in the art as mouse events, the system waits in step 602 for the user to press a mouse button. Once a ‘mouse down’ event is detected in step 602, the system, in step 604, sets the MousePressedAt variable=tₚ where tₚ represents the current time (in thousandths of seconds). It also sets the TrackMouseMovement variable to True in step 606 thereby signaling the system to start monitoring mouse movement events. Following setting the TrackMouseMovement variable in step 606, the system then increments the Total Picks variable by 1 in step 608. This value represents the number of combined mouse down/mouse up interactions the user has executed since the last time a function was executed. In step 610, the system sets the MouseButtonDown flag to True. The status of the MouseButtonDown flag remains true until the mouse button is released. In order to help track dragging operations, the StartedDragging variable is reset to zero in step 612 and the StoppedDragging variable is reset to zero in step 614. The system now sets the Mouse Down Properties in step 616.

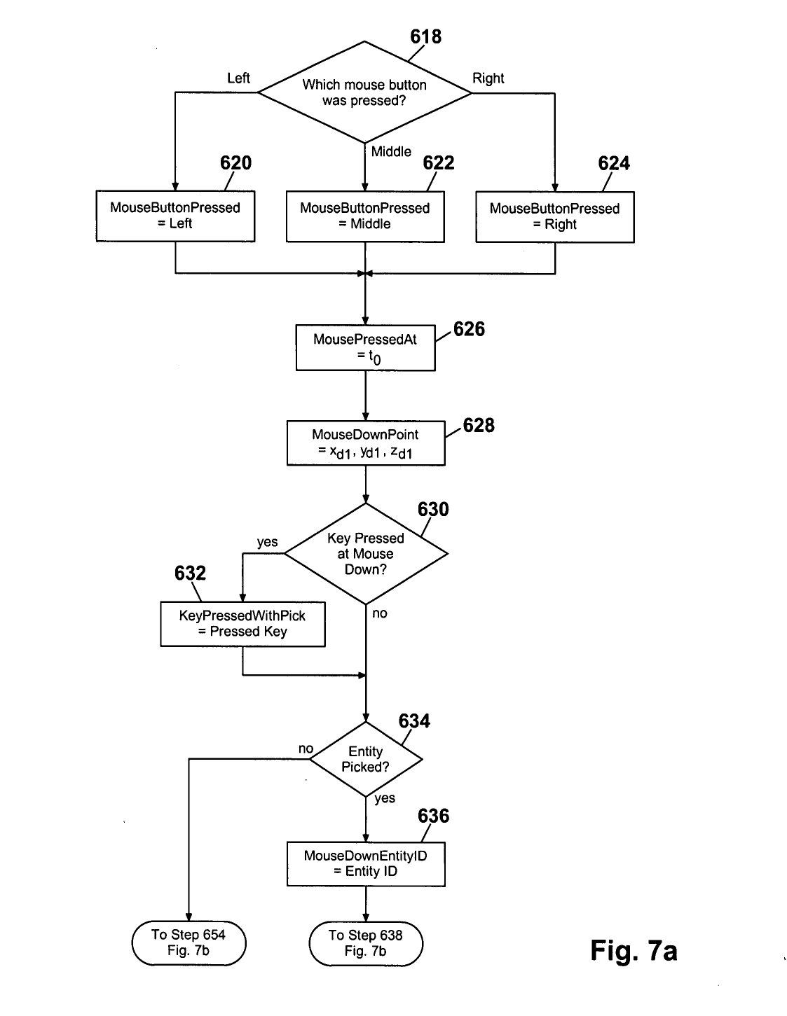

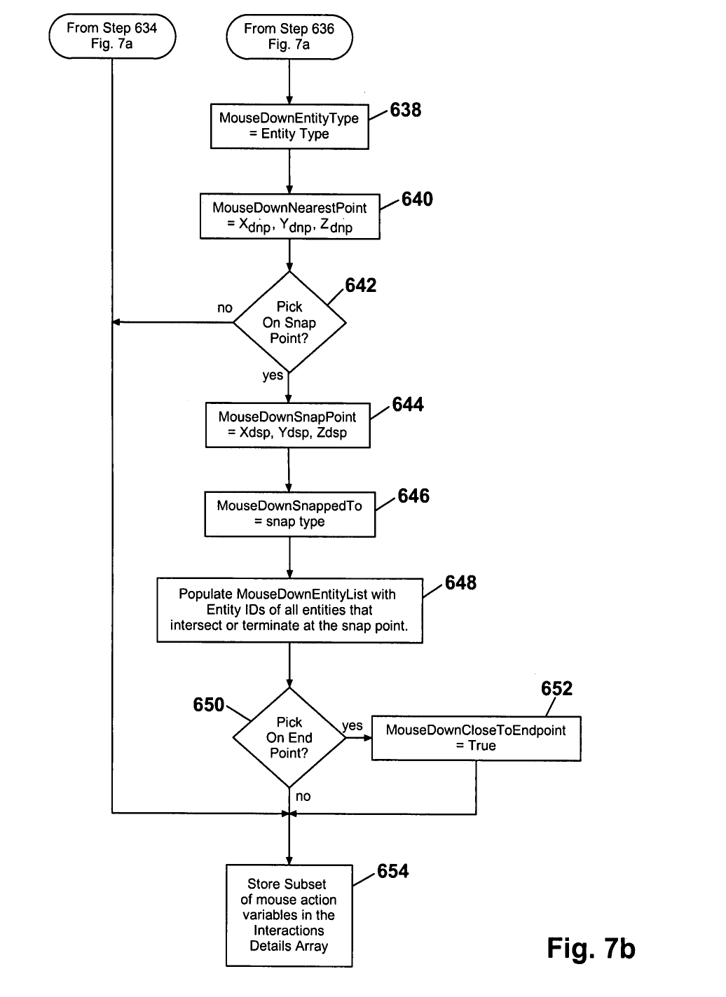

In one embodiment, setting the Mouse Down Properties in step 616 includes assigning values to several variables related to the mouse down event, as shown, for example, in FIG. 7. A determination of which mouse button was pressed is made in step 618 (FIG. 7a). If the left mouse button was pressed, the MouseButtonPressed variable stores “left” (or some other value associated with the left mouse button by the program) in step 620. If the middle mouse button was pressed, the MouseButtonPressed variable stores “middle” (or some other value associated with the middle mouse button by the program) in step 622. If the right mouse button was pressed, the MouseButtonPressed variable stores “right” (or some other value associated with the left mouse button by the program) in step 624. In step 626, the MousePressedAt variable stores the time t₀ when the button was pressed. In one embodiment t₀ is in thousandths of seconds. In step 628 the x-y-z coordinates of the cursor location on the screen at the time of the mouse down event are assigned to the value of the variable MouseDownPoint (MouseDownPoint=x_{d}, y_{d}, z_{d}).

Those skilled in the art will recognize that the number of predetermined interactions may be increased by distinguishing between interactions occurring while no key on the keyboard is depressed and interactions occurring when specific keys on the keyboard are depressed. Thus, if it is determined in step 630 that a key on the keyboard (or other input device) is being pressed at the time of the Mouse Down event, some variable, such as the ASCII value associated with the key being pressed is associated with the KeyPressedWithPick variable in step 632. Not only is the location of the pick point on the screen determined, but the disclosed interface determines and stores whether the pick point occurred on an entity, endpoint or entity snap point. As shown, for example, in FIG. 7, if it is determined in step 634 that the pick point associated with the Mouse Down event is on an entity, the ID of the picked entity is stored in the MouseDownEntityID variable in step 636. The type of entity that was picked is stored in the MouseDownEntityType variable in step 638 (FIG. 7b). Similarly, if it is determined in step 634 that the pick point is on an entity, the x-y-z coordinates of the nearest point on the entity are stored in the MouseDownNearestPoint variable (MouseDownNearestPoint=xₙₚ, yₙₚ, zₙₚ) in step 640.

If it is determined in step 642 that the cursor was located on an entity snap point at the time that the Mouse Down event was detected, the x-y-z coordinates of the entity snap point are stored in the MouseDownSnapPoint variable (MouseDownSnapPoint=xₛₚ, yₛₚ, zₛₚ) in step 644. In step 646 the system stores the type of snap point the user picked in the MouseDownSnappedTo varaible. In step 648, the MouseDownEntityList variable is populated with a list of the entity IDs of each entity that intersects or terminates at the snap point. Thus, not only is information regarding the location of the pick point stored in the system but also a list of entities that intersect or terminate at the snap point is stored. Also, if it is determined in step 650 that the cursor was located very near the endpoint of an object, the MouseDownCloseToEndpoint is set to true in step 652. Finally, a subset of the variable values are added to the Interactions Details Array in step 654.

Returning to step 656 (FIG. 6), the system continues to monitor the output of the pointing device to determine if a mouse movement has occurred in step 656 or whether the mouse button has been released in step 664. When a mouse movement event is detected while a mouse button is depressed in step 656, the current time t_{d1} (in thousandths of seconds) is stored in the StartedDragging variable in step 658. The system continues to monitor the output of the pointing device to determine whether the mouse movement has stopped in step 660. Once the movement stops the current time t_{d2} stored in the StoppedDragging variable in step 662. While the drawings indicate that the system monitors the output of the pointing device to determine whether the mouse button has been released in step 664, those skilled in the art will recognize that the system continues monitoring whether the mouse button has been released during all of the above described steps following detection of the mouse down event.

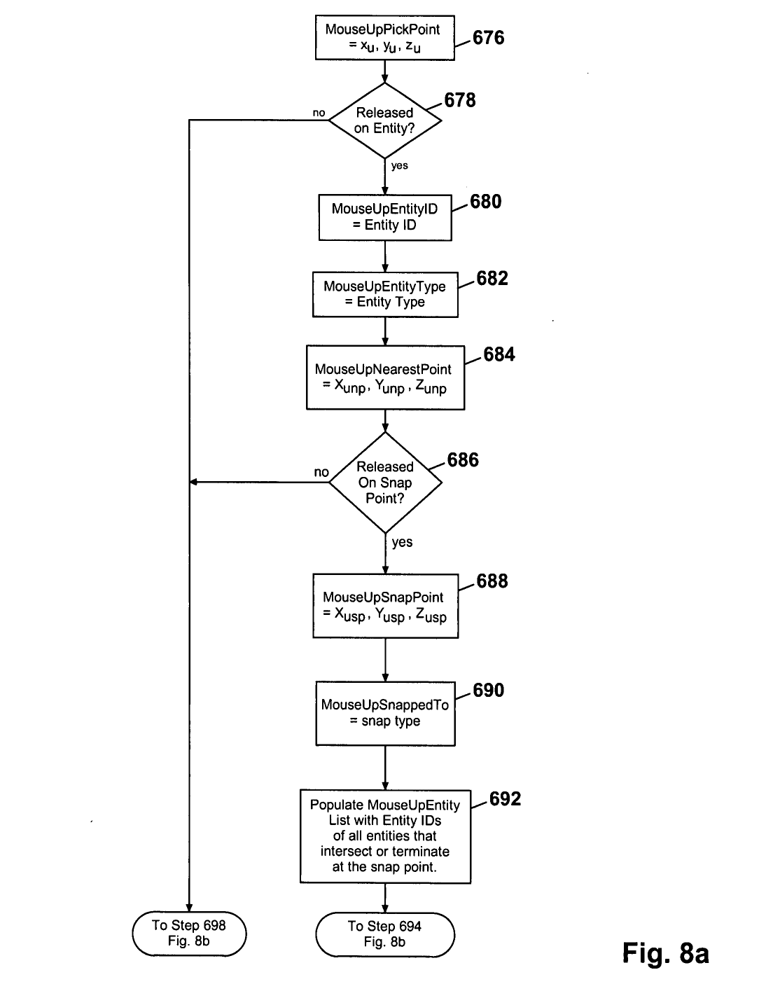

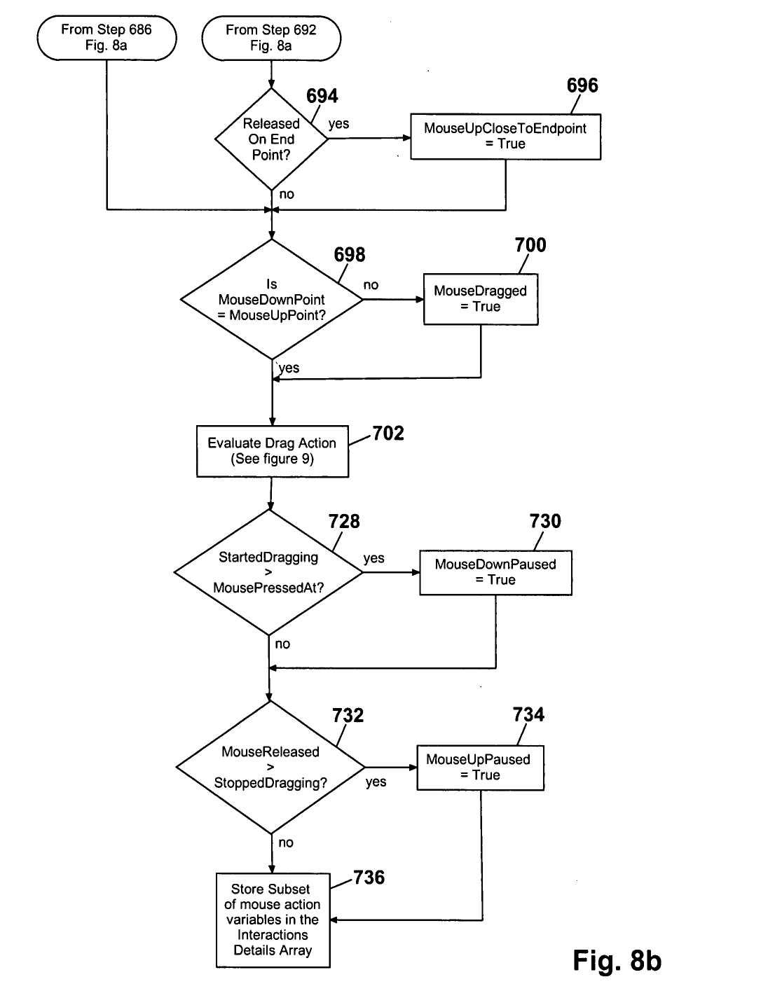

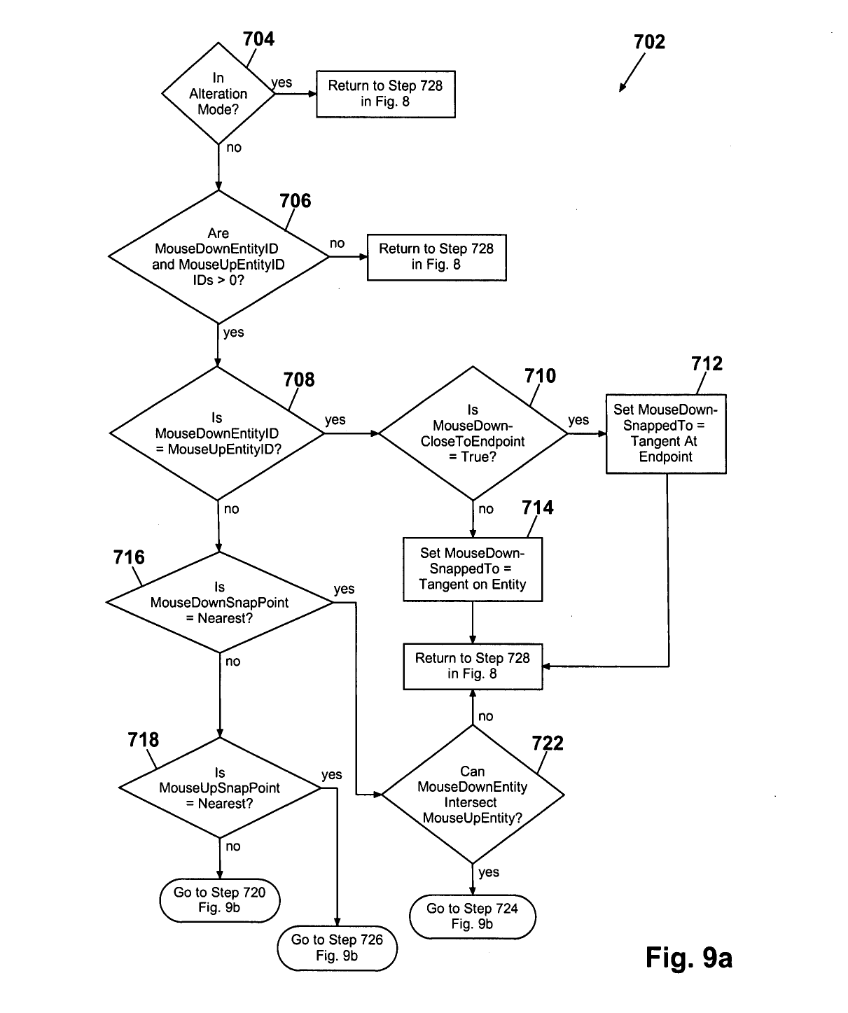

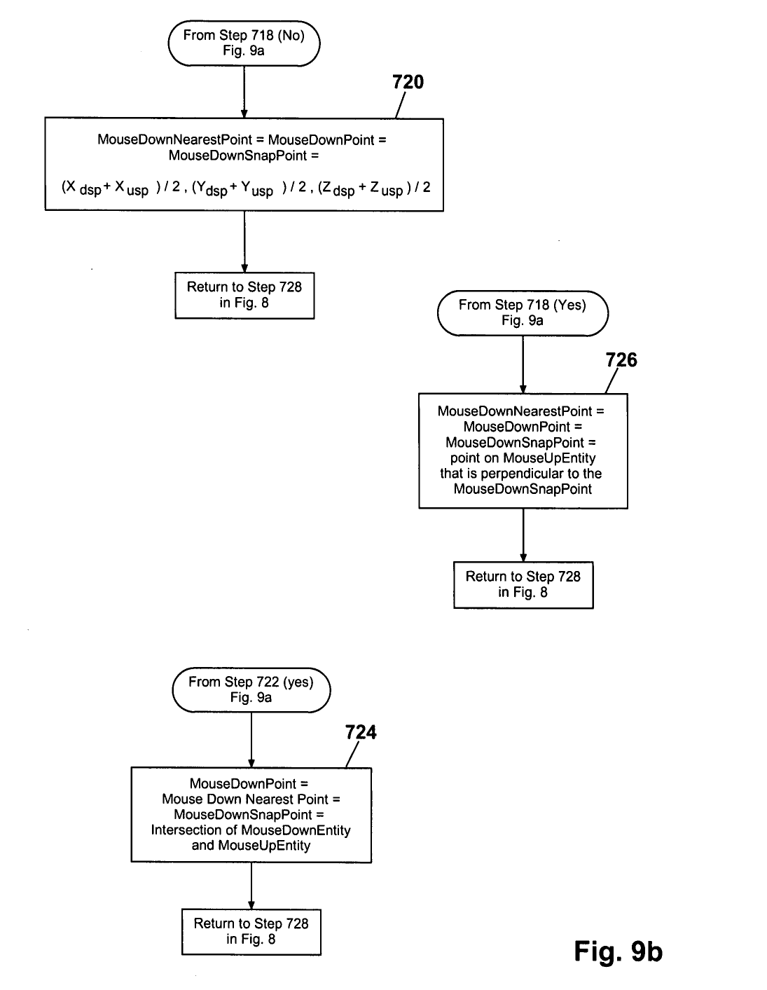

When it has been determined that the mouse button has been released in step 664 the MouseButtonDown variable is set to False in step 666. The time tᵣ at which the mouse up event occurred is stored in the MouseReleasedAt variable in step 668. In one embodiment, the time at which the mouse up event occurred is stored in thousandths of seconds. Since, following the mouse up event, the system is no longer required to track mouse movement, other than through normal tracking to position the cursor in the desired location on the screen, the TrackMouseMovement flag is set to False in step 670. When the TrackMouseMovement flag is set to False, the system stops monitoring mouse movement events. The system then sets the Mouse Up properties in step 672, as shown, for example, in FIG. 8. Once the ‘mouse up’ event is detected the system again sets various flags and assigns values to various variables.

In step 676 (FIG. 8a), the system stores the actual screen coordinates where the cursor was located when the button was released (xᵤ, yᵤ, zᵤ) in the variable MouseUpPickPoint. In step 678, the system determines whether the button was released while the cursor was on an entity. If so, in step 680, the system stores the ID of the entity the cursor was on when the button was released in the MouseUpEntityID variable. Then, in step 682, the system stores the type of entity the button was released on in the MouseUpEntityType variable. Then in step 684, the system stores the nearest point on the entity (xᵤₙₚ, yᵤₙₚ, zᵤₙₚ) the button was released on in the MouseUpNearestPoint variable. In step 686 the system determines whether the button was released while the cursor was “on” an entity snap point. If so, in step 688, the system stores the x-y-z screen coordinate of the entity snap point (xᵤₛₚ, yᵤₛₚ, zᵤₛₚ) the user released the mouse button on in the MouseUpSnapPoint variable. In step 690, the system sets the MouseUpSnappedTo variable to the type of snap point the user released the mouse button on. In step 692, the system stores a list of the IDs of all entities intersecting or terminating at the snap point the button was released on in the MouseUpEntityList variable. In step 694 (FIG. 8b), the system determines whether the button was released while the cursor was very near the endpoint of the entity. If so, in step 696, the MouseUpCloseToEndpoint flag is set to true.

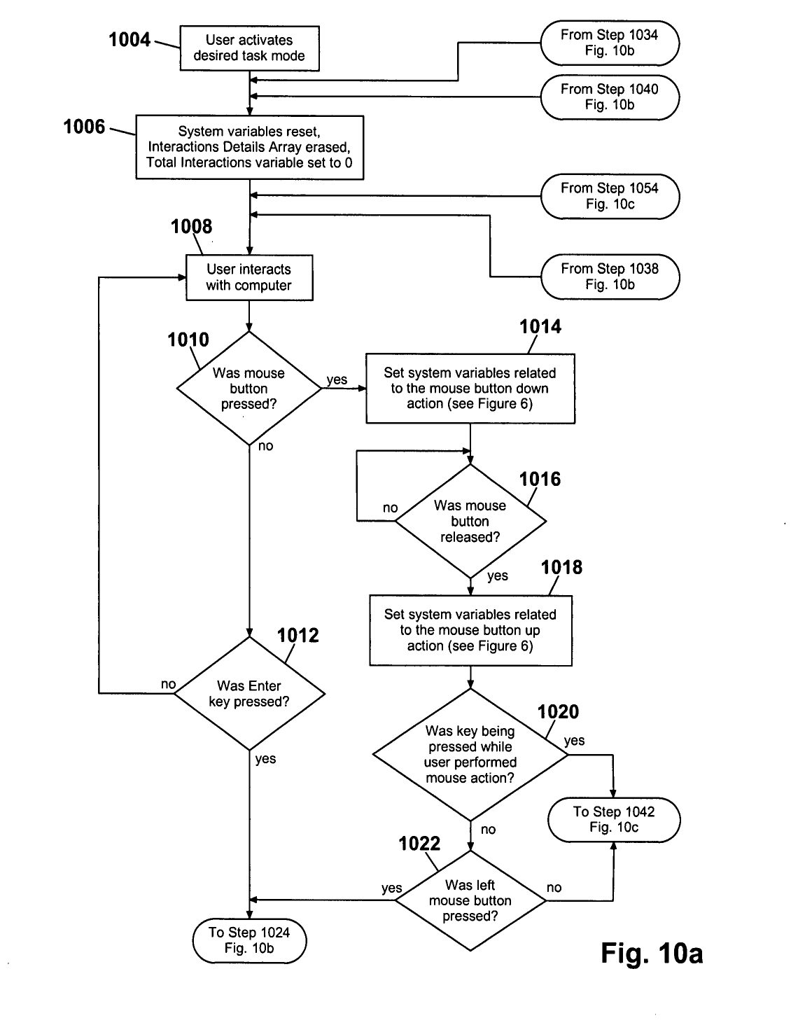

In step 698, the system determines if the MouseDownPoint is the same point (equal to) as the MouseUpPoint in order to determine if the mouse was dragged. If the MouseDownPoint is not the same as the MouseUpPoint, the MouseDragged flag is set to true in step 700. Then, in step 702 (FIG. 9), the system analyzes the drag action to determine if the user had intended to select a point other than the original pick point.

This operation, step 702, of analyzing the drag action in order to determine if the values of the MouseDownPoint, MouseDownNearestPoint, and MouseDownSnapPoint are to be updated is shown, for example, in FIG. 9. If it is determined in step 704 that the user is not working in the Alteration mode, the system checks, in step 706, if both the MouseDownEntityID and the MouseUpEntityID are greater than zero. If so, it continues to step 708 otherwise it returns to step 728 in FIG. 8.

In step 708 the system determines if the MouseDownEntityID is equal to the MouseUpEntityID. If so, it is determined that the user dragged from and to a point on the same entity. It then, in step 710, checks if the MouseDownCloseToEndpoint value is equal to True. If so, the MouseDownSnappedTo value is updated to ‘Tangent at Endpoint’ in step 712. If not, the MouseDownSnappedTo value is updated to ‘Tangent on Entity’ in step 714. In either case the system then returns to step 728 in FIG. 8.

If, in step 708 it was determined that the MouseDownEntityID was not equal to the MouseUpEntityID, the system then, in step 716, checks if the MouseDownSnappedTo value is equal to ‘Nearest’. If so, the system determines, in step 722, if the entity whose ID is equal to the MouseDownEntityID value can intersect the entity whose ID is equal to the MouseUpEntityID. If it is determined in step 722 that these 2 entities can theoretically intersect, the system replaces the x-y-z coordinates of the MouseDownPoint, MouseDownNearestPoint, and MouseDownSnapPoint with the x-y-z coordinates of the intersection point and then returns to step 728 in FIG. 8. If however, it was determined in step 722 that the entity whose ID is equal to the MouseDownEntityID value cannot theoretically intersect the entity whose ID is equal to the MouseUpEntityID, the process simply returns to step 728 in FIG. 8.

If, in step 716 it was determined that the MouseDownSnappedTo value was not equal to ‘Nearest’, the system then checks, in step 718, if the MouseUpSnappedTo value is equal to ‘Nearest’. If so, the system, in step 726, calculates the point on the entity, whose ID is equal to the MouseUpEntityID, that is perpendicular to the MouseDownSnapPoint, and replaces the x-y-z coordinates of the MouseDownPoint, MouseDownNearestPoint, and MouseDownSnapPoint with the perpendicular point's x-y-z coordinates. If however, it was determined in step 718 that the MouseUpSnappedTo value was not equal to ‘Nearest’, the system then, in step 720 (FIG. 9b), calculates, i.e. [(x_{dsp}+xᵤₛₚ)/2, (y_{dsp}+y_{yusp})/2, (z_{dsp}+zᵤₛₚ)/2] the point located midway between the MouseDownSnapPoint and MouseUpSnapPoint and replaces the x-y-z coordinates of the MouseDownPoint, MouseDownNearestPoint, and MouseDownSnapPoint with the midway point's x-y-z coordinates. In either case the system returns to step 728 in FIG. 8.

Upon returning to step 728 (FIG. 8b), the system determines whether the StartedDragging time is greater than the MousePressedAt time. If so, the MouseDownPaused flag is set to true in step 730. Then, in step 732, the system determines whether the MouseReleasedAt time is greater than the StoppedDragging time. If so, the MouseUpPaused flag is set to true in step 734.

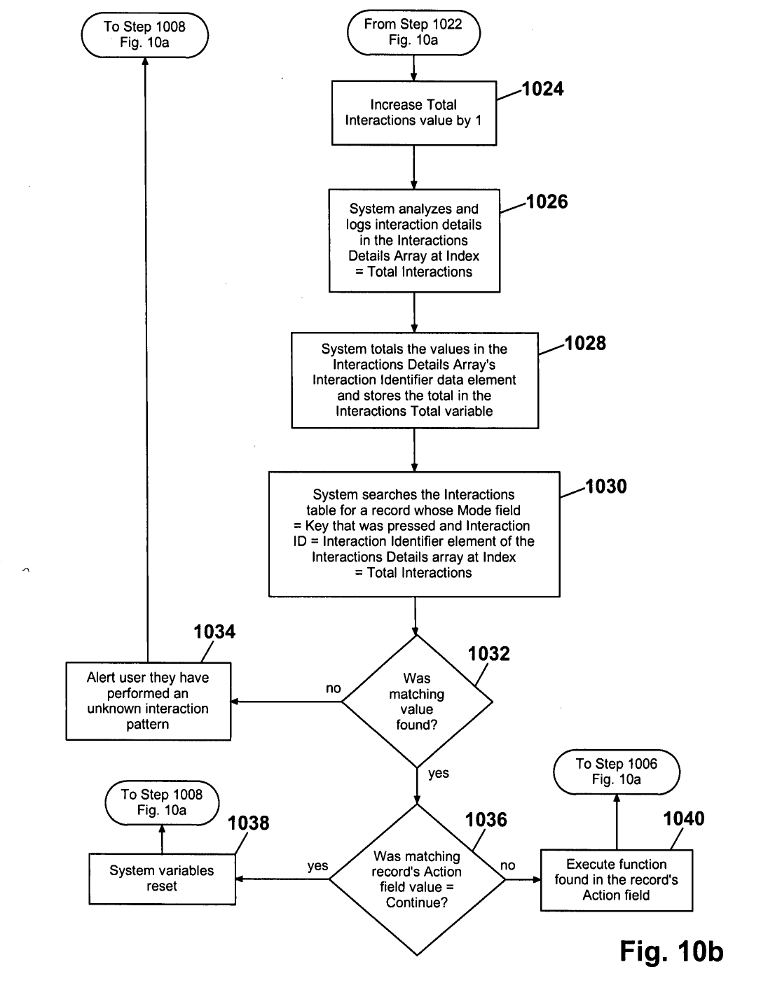

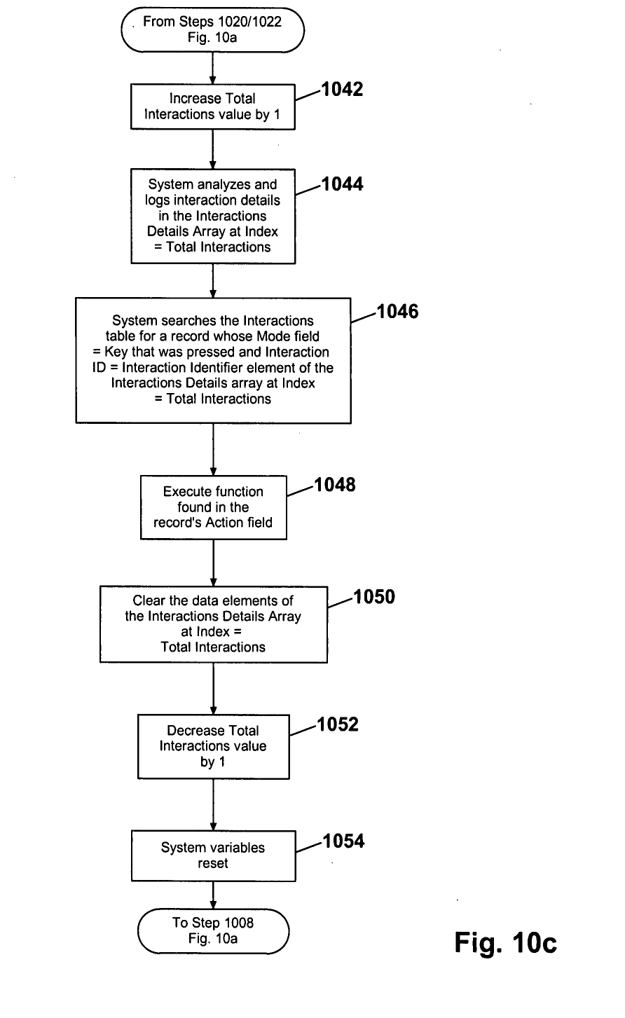

After the mouse button has been released and it is determined that all of the variable, flag and data structure values have been set, the software then proceeds to the Task Interaction Pattern Recognition (TIPR) step, as shown, for example, in FIG. 10. It should be recalled that in steps 225 and 235, a predefined interaction pattern and task mode are established for each of the functions executable using interaction patterns. Establishing these interaction patterns is preferably performed at the time that the software is developed and the interaction patterns associated with each function that can be performed using interaction patterns is documented in hardcopy or electronic documentation for the software to permit the user to become acquainted with the interaction patterns associated with each function.

As shown, for example, in FIG. 10, the Task Interaction Pattern Recognition step includes an interaction monitoring process 1002. In step 1004 the User activates the desired task mode. In one example, this is accomplished by the user pressing the predefined key combination associated with the task mode in which the user desires to work in. Upon activating the desired task mode in step 1004, the system variables are reset in step 1006. In the illustrated embodiment, the system variables are reset 1006 by erasing the interactions details Array and setting the total interactions variable to zero.

The user then interacts with the computer using the user interface in step 1008. The system determines whether a mouse button was pushed in step 1010 and if not, whether the ENTER key was pressed in step 1012, using standard monitoring of user interface inputs. If it is determined in step 1010 that a mouse button was not pressed and it is determined in step 1012 that the ENTER key was not pressed, then the system waits for another user interaction by looping back to step 1008.

If it is determined in step 1010 that a mouse button was pressed, then the system variables related to the mouse button down action are set in step 1014. The system then determines whether the mouse button was released in step 1016. If not, it continues to monitor the status of the mouse button by repeatedly looping through step 1016 until it is determined that the mouse button has been released. When it is determined in step 1016 that the mouse button has been released, the system variables related to the mouse button up action are set in step 1018. In one specific embodiment, step 1018 includes those steps described with reference to FIGS. 6 and 8.

Once the mouse up variables are set, it is determined in step 1020 whether a key was being depressed while the user performed the mouse action, if not, it is determined in step 1022 whether the left mouse button was pressed. If a key was being pressed while the mouse action was performed or the right mouse button was pressed, step 1042 of increasing the Total Interactions value by one is performed. The steps following step 1042 are described five paragraphs below. If a key was not being pressed and the left mouse button was pressed, step 1024 of increasing the Total Interactions value by one is performed.

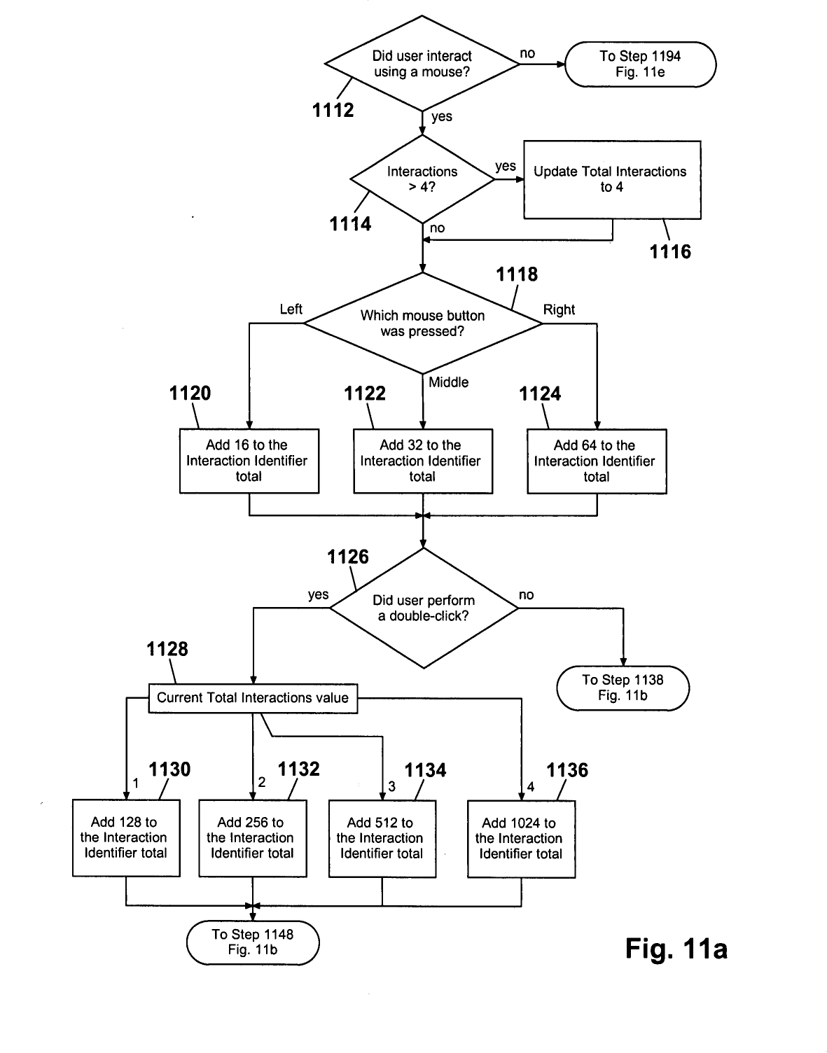

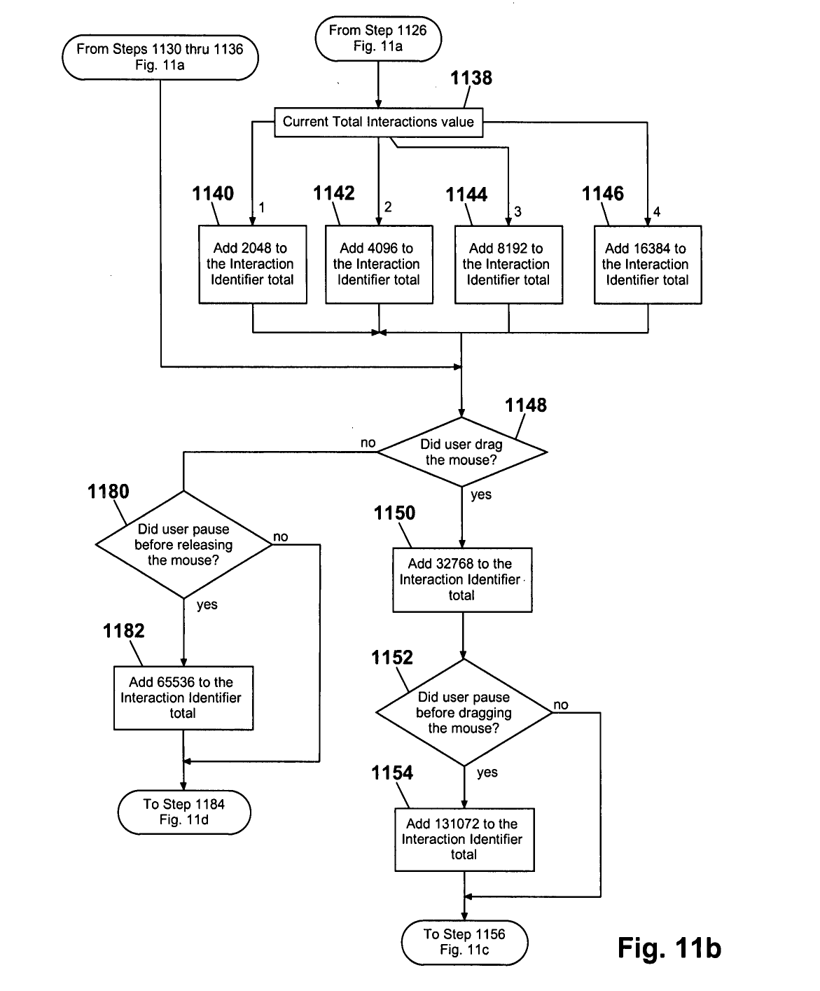

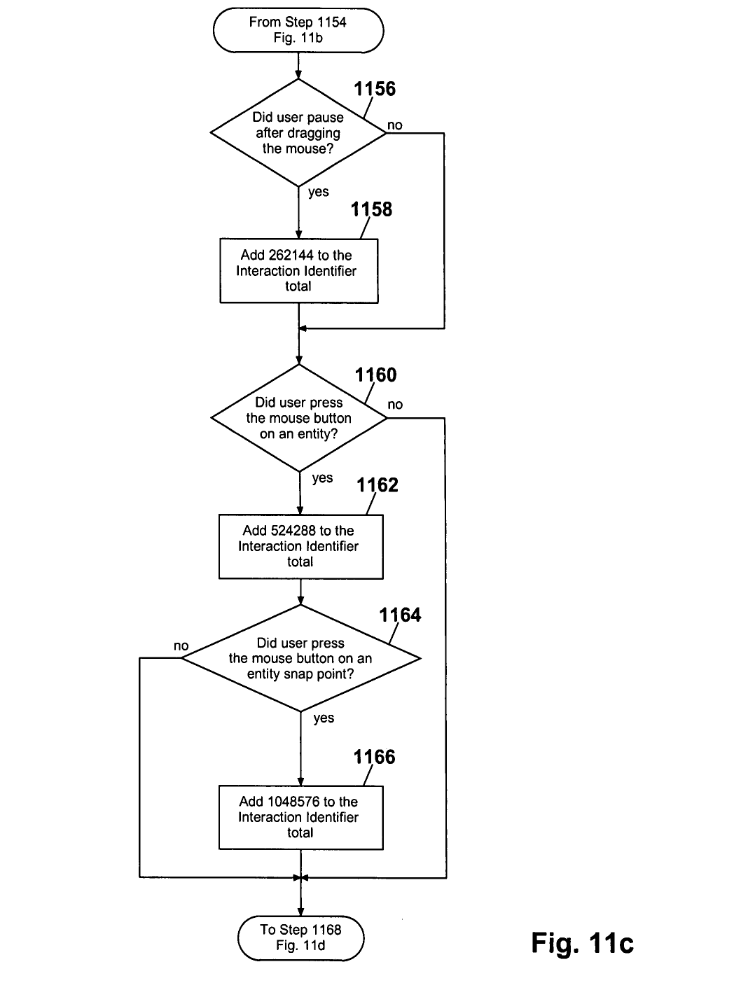

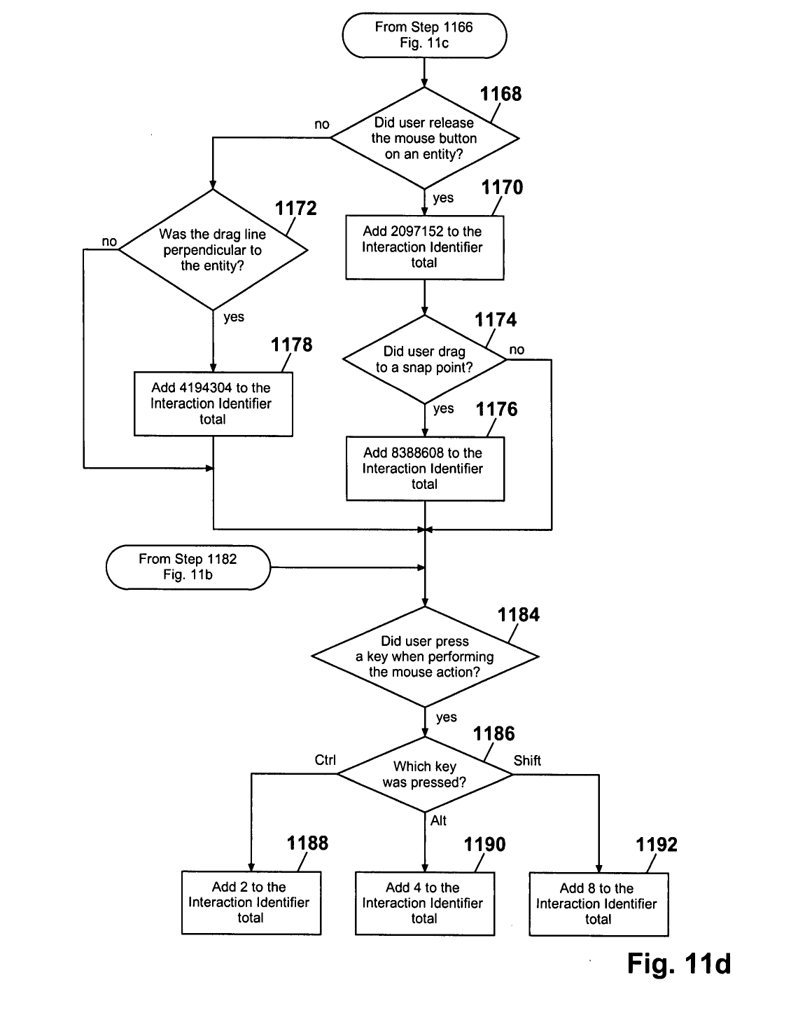

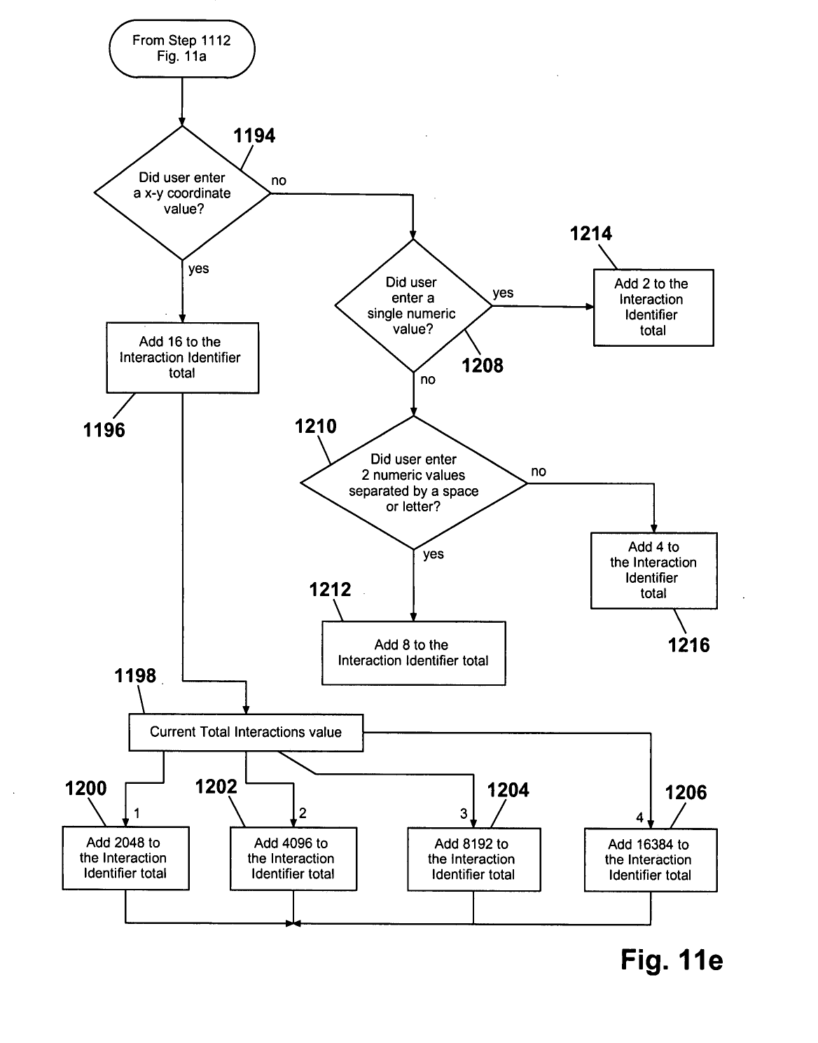

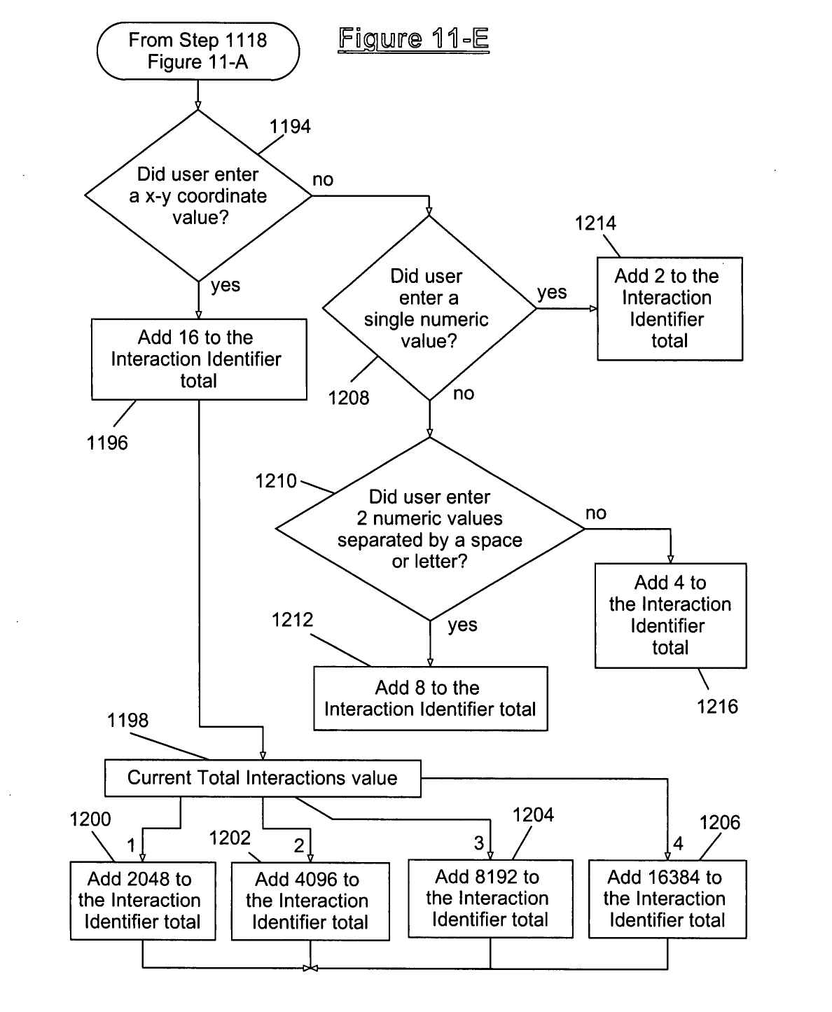

After increasing the Total Interactions value by one in step 1024 (FIG. 10b), the system analyzes and logs interaction details in the Interactions Details array at index=Total Interactions in step 1026. The system totals the values in the Interactions Details Array's Interaction Identifier data elements and stores the total in the Interactions Total variable in step 1028. This step is described in greater detail in FIG. 11.

The system searches the interactions table for a record whose Mode field is the same as the current task mode and whose interaction ID is the same as the Interactions Total variable in step 1030 (FIG. 10b). In step 1032 it is determined if a matching value was found during the search performed in step 1030. If not, the user is alerted in step 1034 that they have performed an unknown interaction pattern. Following the determination that an unknown interaction pattern was performed in step 1034, the system loops back to step 1006 where the system variables are reset, the interactions Details Array is erased and the Total Interactions Variable is reset to zero. The system then proceeds to step 1008 where it waits for the user to interact with the computer again.

If in step 1032 it is determined that a matching value was found in the Interactions table for the currently performed interaction, then in step 1036 it is determined whether the matching record's Action field value is “continue”. The presence of “continue” or some value recognized by the system as representing “continue” in the Action Field Value of a record indicates that all of the interaction patterns required for completion of an indication that the function associated with the record has not yet been completed and that an additional interaction needs to be recognized. Therefore, in step 1038 the system variables are reset but the Interactions Detail Array is left intact and the total interactions variable is left at its current value to be incremented following the next interaction. The system loops back to step 1008 and awaits another interaction by the user.

If the matching records action field is not determined to be “continue” in step 1036 then there is a function in the record's action field. Thus, in step 1040, the system executes the function found in the record's action field and the returns to step 1006 to clear variables and arrays in anticipation of the next user interaction.

As mentioned five paragraphs above, if a key was being depressed during the user interaction or the right mouse button was being depressed during the user interaction, the system increments the value of Total interactions by one in step 1042 (FIG. 10c). After increasing the Total Interactions value by one in step 1042, the system analyzes and logs interaction details in the Interactions Details array at index=Total Interactions in step 1044. The system searches the interactions table for a record whose Mode field is the same as the key that was depressed during the interaction and whose interaction ID is the same as the Interactions Detail Array index at Total Interactions in step 1046. The system then executes the function found in the record's Action field in step 1048. The system clears the data elements of the Interactions Details array at the Total Interactions index in step 1050. The system then decrements the Total Interactions value by one in step 1052 and resets the system variables in step 1054 and loops back to step 1008 to await another user interaction.

The process of how the value is assigned to the user's interaction and how the value that is placed in the Interaction Identifier data element in the Interactions Details array is calculated is shown, for example, in FIG. 11. In step 1112 the system determines whether the user interacted with the program using a mouse. If the user interacted with the program using a mouse, the system checks in step 1114 to see if the Total Interactions value is greater than four. If the value is greater than four, the system sets the Total Interactions value to four in step 1116. The system then determines which mouse button was pressed in step 1118. If it is determined in step 1118 that the left mouse button was pressed, the interaction identifier total is increased by sixteen (i.e. 2⁴) in step 1120. However, if it is determined in step 1118 that the middle mouse button was pressed, the interaction identifier total is increased by thirty-two (i.e. 2⁵) in step 1122. Finally, if it is determined in step 1118 that the right mouse button was pressed, the interaction identifier total is increased by sixty-four (i.e. 2⁶) in step 1124.

Regardless of whether the right, middle or left mouse button was pressed, after appropriately increasing the interaction identifier total in step 1120, 1122 or 1124, it is determined in step 1126 whether the user performed a double click mouse action. If so, the system checks the Total Interactions value in step 1128 and increases the interaction identifier total by the number associated with the current Total Interactions value. If the Total Interactions value is equal to one, the system, in step 1130 increases the interaction identifier by one hundred twenty-eight (i.e. 2⁷). If the value is equal to two, the system increases the interaction identifier by two hundred fifty-six (i.e. 2⁸) in step 1132. Likewise, if the value is equal to three, the system increases the interaction identifier by five hundred twelve (i.e. 2⁹) in step 1134 and finally, if the Total Interactions value is equal to four, the system increases the interaction identifier by one thousand twenty-four (i.e. 2¹⁰) in step 1136.

If it was determined in step 1126 that the user did not perform a double-click mouse action, the TIPR process proceeds to step 1138 where the system checks the Total Interactions value and increases the interaction identifier total by the number associated with the current Total Interactions value. If the Total Interactions value is equal to one, then system, in step 1140 increases the interaction identifier by two thousand forty-eight (i.e. 2¹¹). If the value is equal to two, the system increases the interaction identifier by four thousand ninety-six (i.e. 2¹²) in step 1142. Likewise, if the value is equal to three, the system increases the interaction identifier by eight thousand one hundred ninety-two (i.e. 2¹³) in step 1144 and finally, if the Total Interactions value is equal to four, the system increases the interaction identifier by sixteen thousand three hundred eighty-four (i.e. 2¹⁴) in step 1146.

Regardless of whether a double click occurred or not, after appropriately increasing the value of the interaction identifier total in steps 1130, 1132, 1134, 1136, 1140, 1142, 1144, or 1146, the system then determines whether the user dragged the mouse during the interaction in step 1148. If the user dragged the mouse, the interaction identifier total is increased by thirty two thousand seven hundred sixty-eight (i.e. 2¹⁵) in step 1150. It is then determined in step 1152 if the user paused before dragging the mouse, if so, the Interaction Identifier total is increased by one hundred thirty one thousand seventy-two (i.e. 2¹⁷) in step. 1154 and then a determination is made in step 1156 of whether the user paused after dragging the mouse. If the user did not pause before dragging the mouse, the system proceeds directly from step 1152 to step 1156 without increasing the value of the interaction identifier total.

If it is determined in step 1156 that the user paused after dragging the mouse, the value of the interaction identifier total is increased by two hundred sixty-two thousand one hundred forty-four (i.e. 2¹⁸) in step 1158 before proceeding to step 1160 of determining whether the user pressed the mouse button while the cursor was on an entity. If it is determined in step 1156 that the user did not pause after the dragging operation then the system proceeds directly to step 1160 without modifying the value of the interaction identifier total. If it is determined in step 1160 that the user pressed the mouse button while the cursor was on an entity the value of the interaction identifier total is increased by five hundred twenty-four thousand two hundred eighty-eight (i.e. 2¹⁹) in step 1162. It is then determined in step 1164 whether the user pressed the mouse button while the cursor was over an entity snap point and if so the value of the interaction identifier total is increased by one million forty-eight thousand five hundred seventy-six (i.e. 2²⁰) in step 1166. After appropriately increasing the value of the interaction identifier total, the system proceeds to step 1168 (FIG. 11d) where it is determined whether the user released the mouse button on an entity. As shown, in FIG. 11c the system proceeds to step 1168 directly from step 1160 if the user did not press the mouse button while the cursor was on an entity and directly from step 1164 if the user did not press the mouse button while the cursor was on an entity snap point without further modifying the interaction identifier total.

If it is determined in step 1168 that the user released the mouse button on an entity then the value of the interaction identifier total is increase by two million ninety-seven thousand one hundred fifty-two (i.e. 2²¹) in step 1170. After appropriately increasing the interaction identifier total the system determines in step 1174 whether the user dragged the mouse to place the cursor over a snap point on an entity. If so, the value of the interaction identifier total is increase by eight million three hundred eighty-eight thousand six hundred eight (i.e. 2²³) in step 1176 and the system proceeds to step 1184 wherein it is determined whether the user pressed a key while performing the mouse action. If it is determined in step 1168 that the user did not release the mouse button while the cursor was on an entity, then it is determined in step 1172 whether the user dragged the cursor in a direction mostly perpendicular to an entity. If so, the interaction identifier total is increased by four million one hundred ninety-four thousand three hundred four (i.e. 2²²) in step 1178 before proceeding to step 1184. If it is determined that the drag was not perpendicular to an entity in step 1172, the system advances to step 1184 without further modifying the value of the interaction identifier total. The system also advances to step 1184 when it is determined in step 1148 (FIG. 11b) that the user did not drag the mouse and it is determined in step 1180 that the user did not pause before releasing the mouse button. If however, it is determined in step 1180 that the user did pause before releasing the mouse button, the value of the interaction identifier total is increased by sixty five thousand five hundred thirty-six (i.e. 2¹⁶) in step 1182 before proceeding to step 1184.

In step 1184 it is determined whether the user pressed a key while performing the mouse action. If no key was pressed while the mouse action was being performed, the interaction pattern identification total is not increased and the process of generating the interaction identifier total is complete. If a key was pressed while the mouse action was being performed, it is determined in step 1186 which key was pressed. In the illustrated embodiment, the system recognizes only certain key presses as being valid while a mouse interaction takes place. Illustratively, those keys are the <CTRL> key, the <ALT> key and the <SHIFT> key. If it is determined in step 1186 that the <CTRL> key was pressed while the mouse action was being performed, the value of the interaction identifier total is increased by two (i.e. 2¹) in step 1188. If it is determined in step 1186 that the <ALT> key was pressed while the mouse action was being performed, the value of the interaction identifier total is increased by four (i.e. 2²) in step 1190. If it is determined in step 1186 that the <SHIFT> key was pressed while the mouse action was being performed, the value of the interaction identifier total is increased by eight (i.e. 2³) in step 1192. Steps 1188, 1190 and 1192 are terminal steps in the process of establishing the interaction identifier total.

When it is determined in step 1112 that the user did not interact using a mouse, the system then determines in step 1194 (FIG. 11e) whether the user entered a coordinate value. If so, the value of the interaction identifier total is increased by sixteen (i.e. 2⁴) in step 1196 and the TIPR process proceeds to step 1198 where the system checks the Total Interactions value and increases the interaction identifier total by the number associated with the current Total Interactions value. If the Total Interactions value is equal to one, the system, in step 1200 increases the interaction identifier by two thousand forty-eight (i.e. 2¹¹). If the value is equal to two, the system increases the interaction identifier by four thousand ninety-six (i.e. 2¹²) in step 1202. Likewise, if the value is equal to three, the system increases the interaction identifier by eight thousand one hundred ninety-two (i.e. 2¹³) in step 1204 and finally, if the Total Interactions value is equal to four, the system increases the interaction identifier by sixteen thousand three hundred eighty-four (i.e. 2¹⁴) in step 1206. The amount the interaction identifier is increased by in step 1196 and steps 1200, 1202, 1204, or 1206 is the same as if the user had used the left mouse button to pick a screen point. The TIPR process views the user entering a coordinate value as if they had actually picked a screen point using the left mouse button. If it is determined in step 1194 that the user did not enter a coordinate value, then the system determines in step 1208 whether the user entered a single numeric value. If a single numeric value was entered, then two (i.e. 2¹) is added to the value of the interaction identifier total in step 1214. If a single numeric value was not entered, then the system determines in step 1210 whether two numeric values, separated by a space or a letter were entered. If not, the value of the interaction identifier total is increased by four (i.e. 2²) in step 1216. If it is determined in step 1210 that the user entered two numeric values separated by a space or a letter, then in step 1212 eight (i.e. 2³) is added to the interaction identifier total and the process of establishing the interaction identifier total is complete.

By now, those skilled in the art will recognize that the described manner in which the interaction identifier total is increased is particularly well adapted for implementation in binary systems. The result of any decision step determines the value of only a single bit of the variable representing the interaction identifier total. Thus, identification of the interaction pattern can be accomplished through bit wise comparison of values in the interaction table.

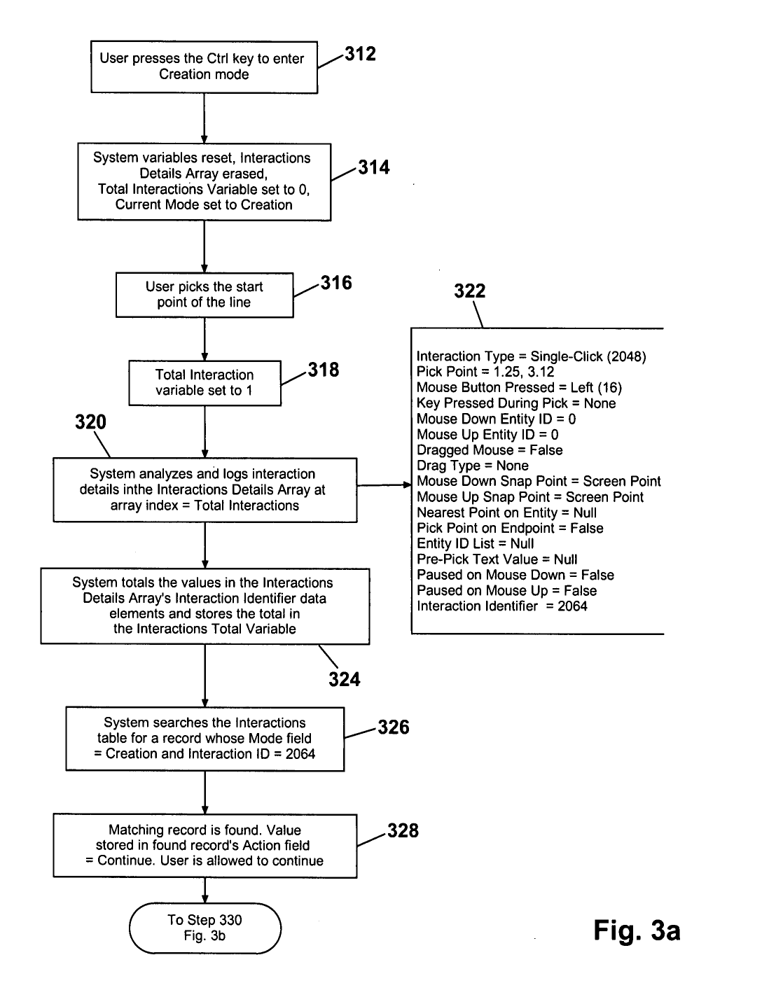

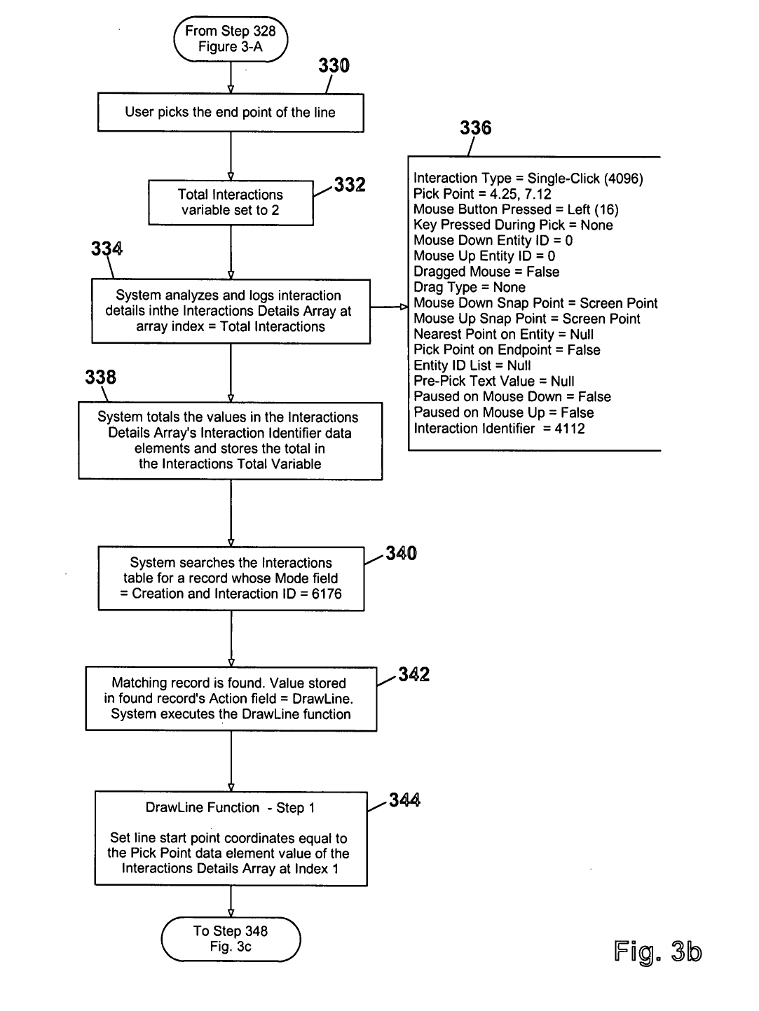

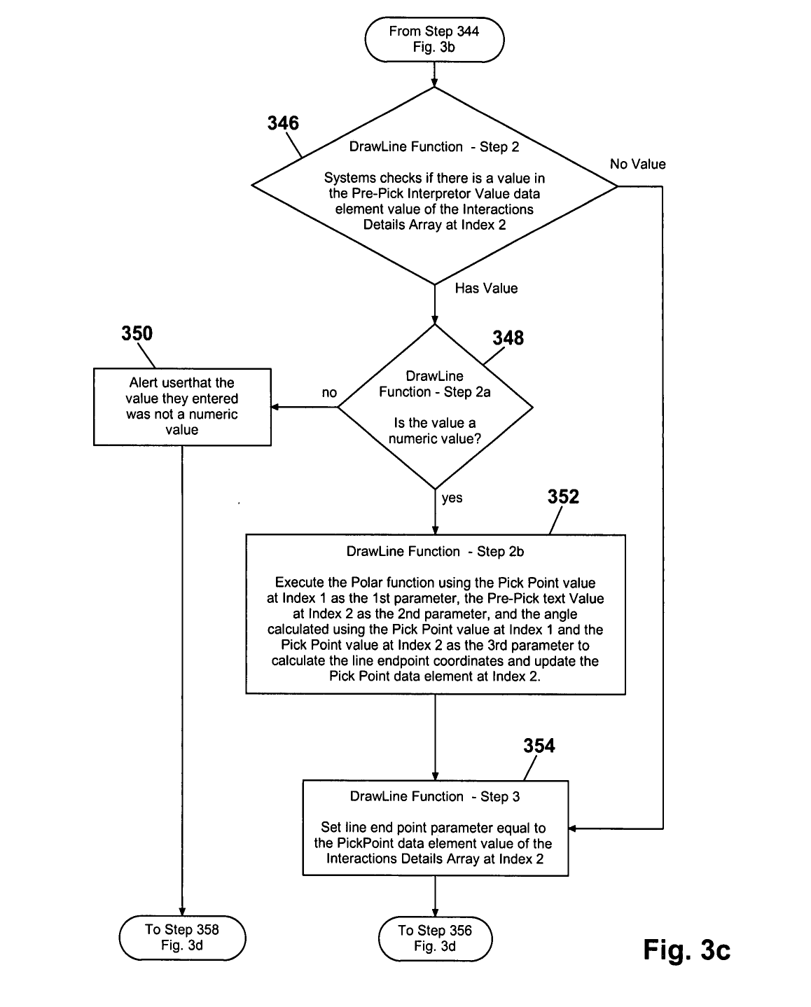

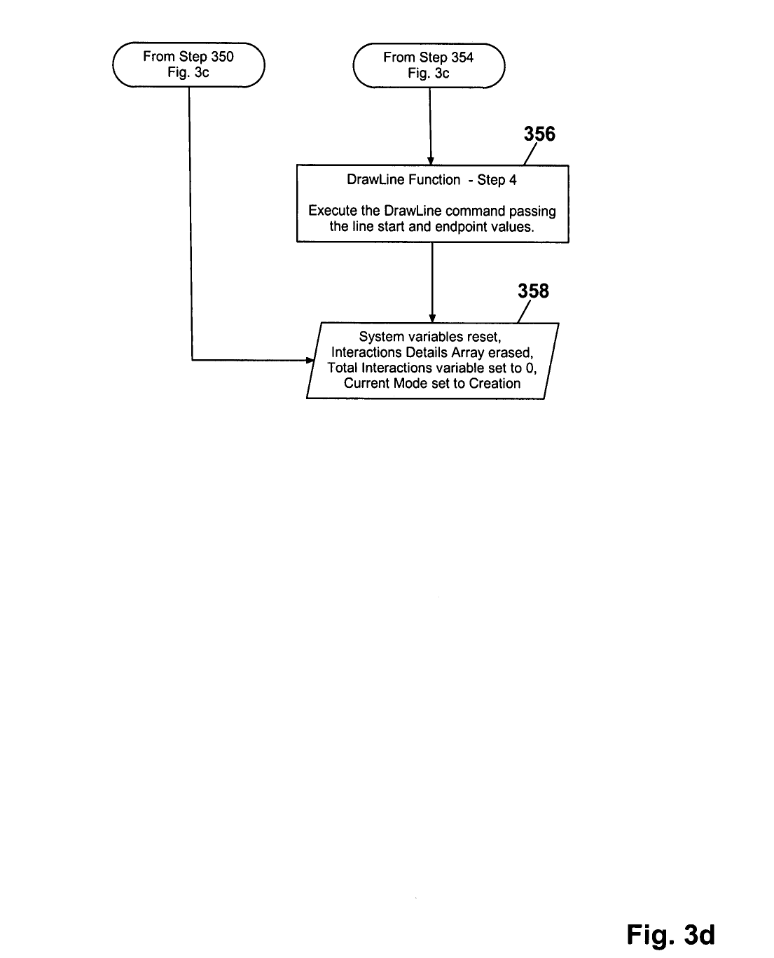

FIG. 3 shows the steps a user takes to implement the Draw Line function interaction and the manner in which the interaction identifier total is varied in response to the draw line function. In order to draw a line, the user enters the creation mode by pressing the <CTRL> key in step 312. This causes the system variables to reset, the Interaction Details array to be erased, the Total interactions variable to be set to zero and the current Mode to be set to Creation in step 314. The user then initiates the draw line pattern by moving the mouse to cause the cursor to be positioned over the desired starting point of the line and single clicks the left mouse button to designate or pick the start point of the line in step 316. Upon selecting the start point, the total interactions variable is incremented to one in step 318. The system analyzes and logs the interaction details in the interactions details array at array index=Total Interactions in step 320. In the example, the user interacted while in the creation mode using the mouse to perform a single left click while the cursor was over a location that did not include an entity or snap point identified by coordinates 1.25, 3.12 and did not pause or drag the mouse or press a key during the interaction. Thus, the Interaction Details array at index one, as shown in step 322, contains the following data: Interaction Type=Single Click (2048); Pick Point=1.25, 3.12; Mouse Button Pressed=Left (16); Key Pressed During Pick=None; Mouse Down Entity ID=0; Mouse up Entity ID=0; Dragged Mouse=False; Drag Type=None; Mouse Down Snap Point=Screen Point; Mouse up Snap Point=Screen Point; Nearest Point on Entity=Null; Pick Point on End Point=False; Entity ID List=Null; Pre-Pick Text Value=Null; Paused on Mouse Down=False; Paused on Mouse up=False; Interaction Identifier=2064.

The system totals the values in the Interactions Details Array's interaction identifier data in accordance with FIG. 11 and stores the total in the Interactions Total variable in step 324. The system then searches the Interactions table for a record whose mode field matches the mode in which the current interaction was performed, illustratively the creation mode, and that includes the same Interaction ID value as the current interaction, illustratively 2064, in step 326. Illustratively a matching record is found that includes “Continue” in its action field so the user is allowed to continue interacting with the system in step 328.

The user then, preferably unaware of the steps that occurred since picking the start point of the line, moves the mouse so that the cursor is located over the location on the screen of the desired end point of the line and picks the end point by single clicking on the left mouse button in step 330. Upon selecting the end point, the total interactions variable is incremented by one in step 332 to a value of two. The system analyzes and logs the interaction details in the interactions details array at array index=Total Interactions in step 334. In the example, the user interacted while in the creation mode using the mouse to perform a single left click while the cursor was over a location that did not include an entity or snap point identified by (4.25, 7.12) and did not pause or drag the mouse or press a key during the interaction. Thus, the Interaction Details array at index two, as shown in step 336, contains the following data: Interaction Type=Single Click (4096); Pick Point=4.25, 7.12; Mouse Button Pressed=Left (16); Key Pressed During Pick=None; Mouse Down Entity ID=0; Mouse up Entity ID=0; Dragged Mouse=False; Drag Type=None; Mouse Down Snap Point=Screen Point; Mouse up Snap Point=Screen Point; Nearest Point on Entity=Null; Pick Point on End Point=False; Entity ID List=Null; Pre-Pick Text Value=Null; Paused on Mouse Down=False; Paused on Mouse up=False; Interaction Identifier=4112

The system totals the values in the Interactions Details Array's interaction identifier data in accordance with FIG. 11 and stores the total in the Interactions Total variable in step 338. The system then searches the Interactions table for a record whose mode field matches the mode in which the current interaction was performed, illustratively the creation mode, and that includes the same Interaction ID value as the current interaction, illustratively 6176, in step 340. The Interaction ID value 6176 is obtained by adding the Interaction ID value at the first index (2064 from step 332) to the Interaction ID value at the second index (4112 from step 336). Illustratively a matching record is found that includes “DrawLine” in its action field in step 342. Once the TIPR determines that the user wants to draw a line it then calls the Draw Line function, which is the code that determines the values needing to be passed to the Draw Line command and then executes the Draw Line command.

The illustrated DrawLine function includes a first step 344 in which the system sets the start point coordinates equal to the Pick point data element value of the Interactions Detail array at index one. In the illustrated example, the pick point data element at index one includes the coordinates 1.25, 3.12. The second step 346 of the draw line function determines if there is a value in the Pre-Pick Interpreter Value data element of the Interactions Detail Array at the second Index. As shown, in step 336, in this example wherein the DrawLine function is called by picking the start and end points of the line, the Pre-Pick Interpreter value is “Null” and thus the DrawLine function proceeds to the third step 354 from step 346.

If, however, it is determined in step 346 that there is a value in the Pre-Pick Text Value data, then the system executes a sub step 348 wherein it determines if the value is a numeric value. If the value of the Pre-Pick Text data is a numeric value then this indicates that the user entered a length for the line segment to be rendered and indicated the start point of the line by clicking while the cursor was over the desired location of the start point and indicated the direction in which the line should extend by clicking while the cursor was over a location along the direction in which the line is to extend. For purposes of this un-illustrated example, let it be assumed that the user, prior to performing the second click entered a value of 5.00 as the Pre-Pick Text Value and performed the second click while the cursor was over the coordinates 7.25, 11.12 (the second pick is on a line extending 10.00 units from the start point (1.25, 3.12) which line also passes through the coordinate 4.25, 7.12 which is displaced 5.00 units from the start point. Thus, if it is determined in sub-step 348 that the value of the Pre-Pick Text data is a numeric value the draw line function executes a sub-step 352 wherein the Polar Functions is executed using the Pick Point value at the first index (in this example 1.25, 3.12) as the first parameter, the Pre-Pick Text Value (in this un-illustrated example 5.00) at the second index as the second parameter and the angle calculated using the Pick Point value at the first index and the Pick Point value at the second index (in this un-illustrated example 7.25, 11.12) as the third parameter to calculate the line endpoint coordinates (in this example, start point 1.25, 7.12 and endpoint 4.25, 7.12) to update the Pick Point value at the second index (in this example 4.25, 7.12) before proceeding to the third step 354 of the DrawLine Function. However, if it is determined in step 348 that the value of the Pre-Pick Text Value is not a numeric value, then the user has performed an improper interaction and is informed in step 350 that the value they entered was not a numeric value and the system resets the system variables, erases the Interaction Details Array, sets the Total Interactions Variable to zero and sets the Current Mode to Creation in step 358 and aborts the Draw line function without rendering a line on the screen.

If the user has properly executed a DrawLine interaction by picking two points using the mouse and either not entering a value in the Pre-Pick Text Value variable (in which case the picked points designate the endpoint coordinates) or entering a numeric value reflecting the length of the segment to be rendered (in which case the first pick point is the start point and the endpoint is calculated as described above in step 352), the third step 354 of the DrawLine function is executed. In the third step 354 of the DrawLine Function, the system sets the line endpoint equal to the Pick Point data element value of the Interactions Details array at the second index (in the illustrated and non-illustrated examples 4.25, 7.12). The Draw Line Function then executes the DrawLine Command by passing the line start and endpoint values to the Draw Line Command, which renders the line on the screen. After passing the appropriate parameters and executing the DrawLine function in step 356 (FIG. 3d) the system the performs step 358 wherein, the system resets the system variables, erases the Interaction Details Array, sets the Total Interactions Variable to zero and sets the Current Mode to Creation.

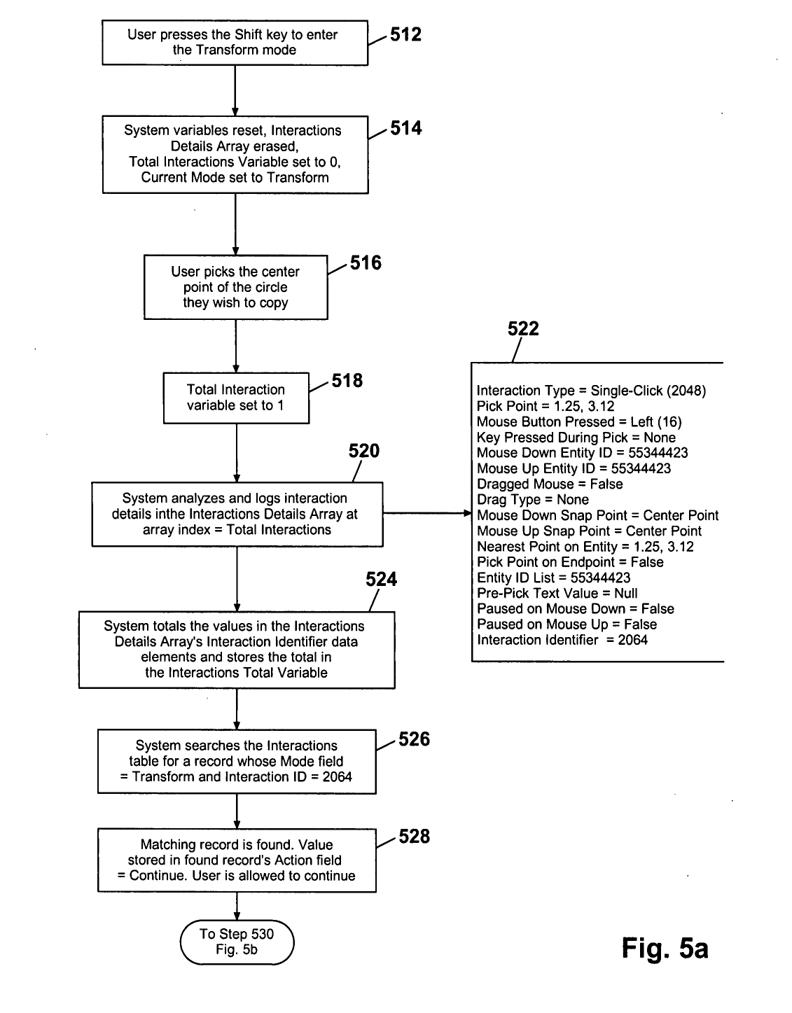

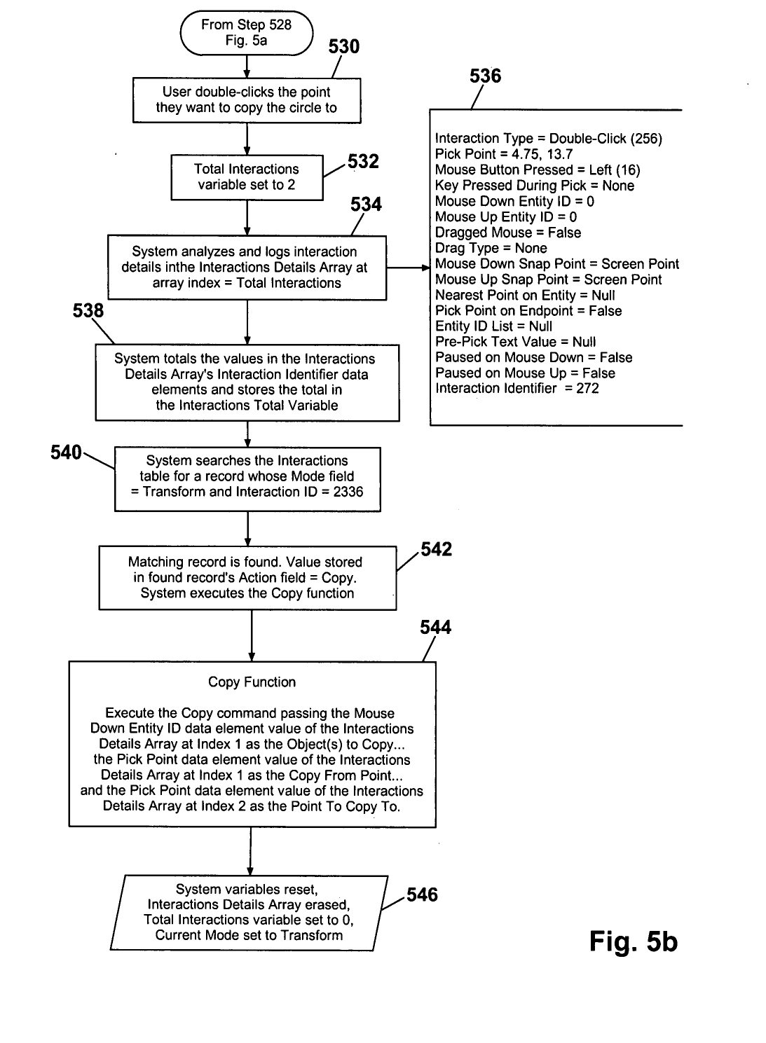

In a second illustrated example, the user interacts with the system to indicate that they desire to copy a circle already rendered on the screen, as shown, for example, in FIG. 5. FIG. 5 shows the steps a user takes to implement Copy Object function and the manner in which the interaction identifier total is varied in response to the Copy Object function pattern.

In order to copy the circle, the user enters the creation mode by pressing the <SHIFT> key in step 512. This causes the system variables to reset, the Interaction Details array to be erased, the Total interactions variable to be set to zero and the current Mode to be set to Transformation in step 514. The user then initiates the copy circle pattern by moving the mouse to cause the cursor to be positioned over the center point of the circle they wish to copy and single clicks the left mouse button to designate or pick the circle to be copied in step 516. In this example, it should be assumed that the circle to be copied has its center point located at coordinates 1.25, 3.12 and is designated by the Entity ID number 55344423. Upon selecting the center point of the circle to be copied, the total interactions variable is incremented to one in step 518. The system analyzes and logs the interaction details in the interactions details array at array index=Total Interactions in step 520. In the example, the user interacted while in the transformation mode using the mouse to perform a single left click while the cursor was over the location of the center point identified by coordinates 1.25, 3.12 of a circle identified by Entity ID number 55344423 and did not pause or drag the mouse or press a key during the interaction. Thus, the Interaction Details array at index one, as shown in step 522, contains the following data: Interaction Type=Single Click (2048); Pick Point=1.25, 3.12; Mouse Button Pressed=Left (16); Key Pressed During Pick=None; Mouse Down Entity ID=55344423; Mouse up Entity ID=55344423; Dragged Mouse=False; Drag Type=None; Mouse Down Snap Point=Center Point; Mouse up Snap Point=Center Point; Nearest Point on Entity=1.25, 3.12; Pick Point on End Point=False; Entity ID List=55344423; Pre-Pick Text Value=Null; Paused on Mouse Down=False; Paused on Mouse up=False; Interaction Identifier=2064.

The system totals the values in the Interactions Details Array's interaction identifier data in accordance with FIG. 11 and stores the total in the Interactions Total variable in step 524. The system then searches the Interactions table for a record whose mode field matches the mode in which the current interaction was performed, illustratively the Transformation mode, and includes the same Interaction ID value as the current interaction, illustratively 2064, in step 526. Illustratively a matching record is found that includes “Continue” in its action field so the user is allowed to continue interacting with the system in step 528.

The user then, preferably unaware of the steps that occurred since picking the center point of the circle to be copied, moves the mouse so that the cursor is located over the location on the screen of the desired center point of the copy of the circle and picks the center point of the copy of the circle by double clicking on the left mouse button in step 530. In the illustrated example, the user double clicks the left mouse button while the cursor is over coordinates 4.75, 13.7 on the screen. Upon selecting the center point for the copy of the circle, the total interactions variable is incremented by one in step 532 to a value of two. The system analyzes and logs the interaction details in the interactions details array at array index=Total Interactions in step 534. In the example, the user interacted while in the transformation mode using the mouse to perform a double left click while the cursor was over a location that did not include an entity or snap point identified by coordinates 4.75, 13.7 and did not pause or drag the mouse or press a key during the interaction. Thus, the Interaction Details array at index two, as shown in step 536, contains the following data: Interaction Type=Double Click (256); Pick Point=4.75, 13.7; Mouse Button Pressed=Left (16); Key Pressed During Pick=None; Mouse Down Entity ID=0; Mouse up Entity ID=0; Dragged Mouse=False; Drag Type=None; Mouse Down Snap Point=Screen Point; Mouse up Snap Point=Screen Point; Nearest Point on Entity=Null; Pick Point on End Point=False; Entity ID List=Null; Pre-Pick Text Value=Null; Paused on Mouse Down=False; Paused on Mouse up=False; Interaction Identifier=272.

The system totals the values in the Interactions Details Array's interaction identifier data in accordance with FIG. 11 and stores the total in the Interactions Total variable in step 538. The system then searches the Interactions table for a record whose mode field matches the mode in which the current interaction was performed, illustratively the transformation mode, and that includes the same Interaction ID value as the current interaction, illustratively 2336 (i.e. Interaction Identifier (First Index (2064))+Interaction Identifier (Second Index (272))), in step 540. Illustratively a matching record is found which record includes “Copy” in its action field in step 542. Once the TIPR determines that the user wants to copy a circle it calls the Copy Object function, which is the code that determines the values needing to be passed to the Copy command, and then executes the Copy command in step 544. Step 544 includes the passing the Mouse down Entity ID data element value of the Interactions Detail Array at the first index as the object to be copied, the Pick point data element value of the interactions Details array at the first index as the Copy from Point and the Pick Point data element value of the Interactions Detail Array at the second index as the Copy to Point to the Copy Command for execution. After passing the appropriate parameters and executing the Copy command in step 544 the system the performs step 546 wherein, the system resets the system variables, erases the Interaction Details Array, sets the Total Interactions Variable to zero and sets the Current Mode to Transformation.

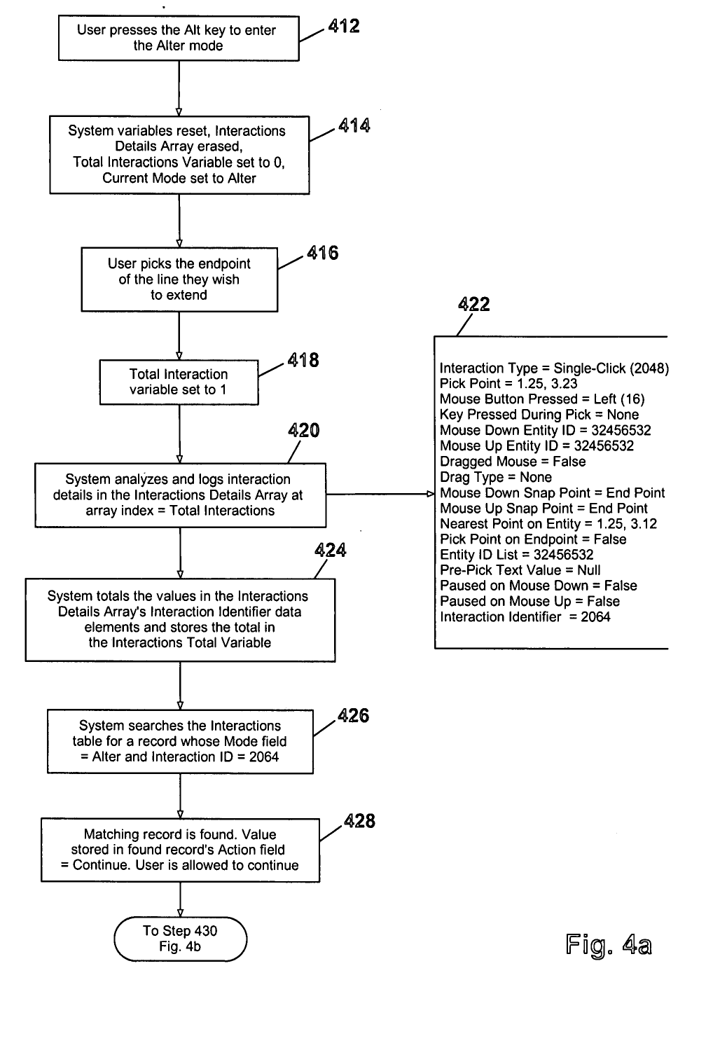

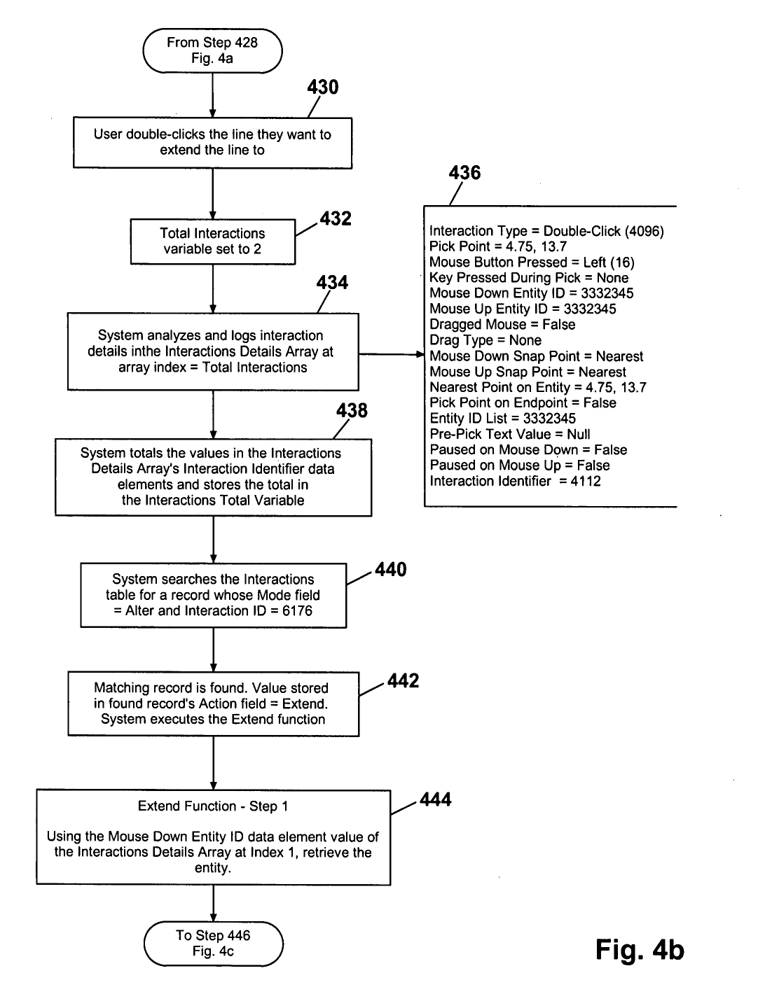

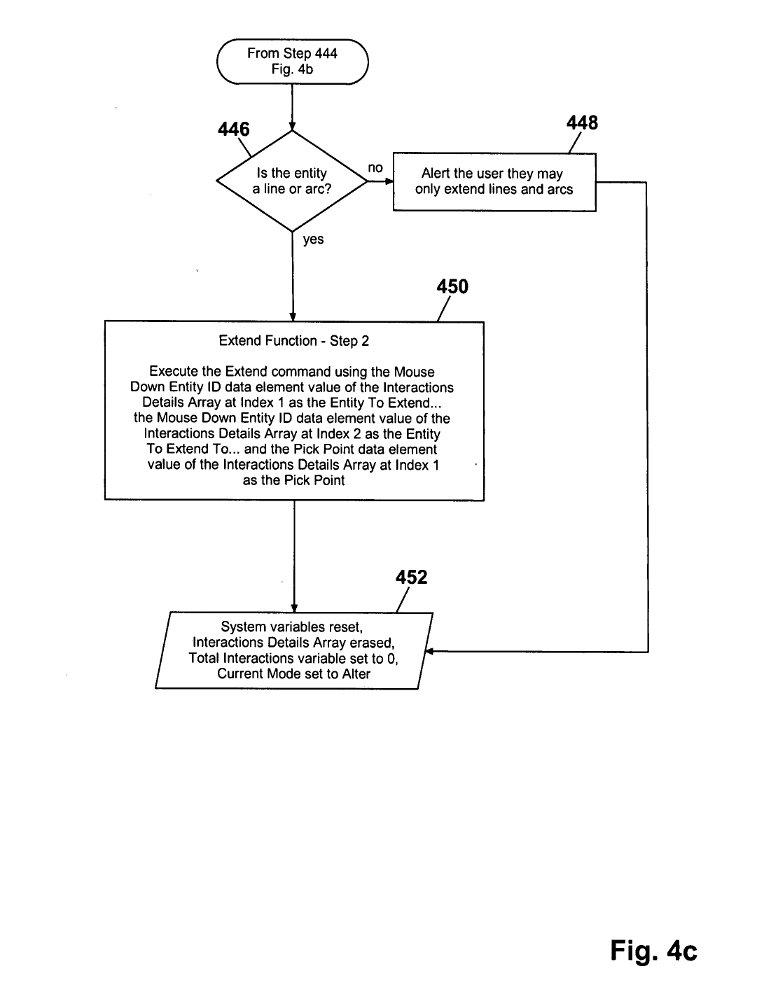

FIG. 4 shows the steps a user takes to implement the Extend Line/Arc function and the manner in which the interaction identifier total is varied in response to the Extend Line/Arc function pattern. In a third illustrated example, the user interacts with the system to indicate that they desire to extend a line to an object already rendered on the screen, as shown, for example, in FIG. 4.

In order to extend a line to an object, the user enters the Alteration mode by pressing the <ALT> key in step 412. This causes the system variables to reset, the Interaction Details array to be erased, the Total interactions variable to be set to zero and the current Mode to be set to Alteration in step 414. The user then initiates the extend line pattern by moving the mouse to cause the cursor to be positioned over or near the end point of the line they wish to extend and single clicks the left mouse button to designate or pick the line to be extended in step 416. In this example, it should be assumed that the line to be copied has its end point located at coordinates 1.25, 3.12 and is designated by the Entity ID number 32456532 but that the user clicks the left button of the mouse when the cursor is located over coordinates 1.25, 3.23, i.e. near the end point of the line. Upon selecting the end point of the line to be extended, the total interactions variable is incremented to one in step 418. The system analyzes and logs the interaction details in the interactions details array at array index=Total Interactions in step 420. In the example, the user interacted while in the alteration mode using the mouse to perform a single left click while the cursor was near (1.25, 3.23) the location of the end point identified by coordinates 1.25, 3.12 of a line identified by Entity ID number 32456532 and did not pause or drag the mouse or press a key during the interaction. Thus, the Interaction Details array at index one, as shown in step 422, contains the following data: Interaction Type=Single Click (2048); Pick Point=1.25, 3.23; Mouse Button Pressed=Left (16); Key Pressed During Pick=None; Mouse Down Entity ID=32456532; Mouse up Entity ID=32456532; Dragged Mouse=False; Drag Type=None; Mouse Down Snap Point=End Point; Mouse up Snap Point=End Point; Nearest Point on Entity=1.25, 3.12; Pick Point on End Point=false; Entity ID List=32456532; Pre-Pick Text Value=Null; Paused on Mouse Down=False; Paused on Mouse up=False; Interaction Identifier=2064.

The system totals the values in the Interactions Details Array's interaction identifier data in accordance with FIG. 11 and stores the total in the Interactions Total variable in step 424. The system then searches the Interactions table for a record whose mode field matches the mode in which the current interaction was performed, illustratively the Alteration mode, and that includes the same Interaction ID value as the current interaction, illustratively 2064, in step 426. Illustratively a matching record is found which record includes “Continue” in its action field so the user is allowed to continue interacting with the system in step 428.

The user then, preferably unaware of the steps that occurred since picking the end point of the line to be extended, moves the mouse so that the cursor is located over the object on the screen to which it is desired that the line be extended and double-clicks the object by clicking on the left mouse button in step 430. In the illustrated example, the user double-clicks the left mouse button while the cursor is over a point on the entity identified by ID 3332435 at coordinates 4.75, 13.7 on the screen. Upon double-clicking the entity to which the line is to be extended to, the total interactions variable is incremented by one in step 432 to a value of two. The system analyzes and logs the interaction details in the interactions details array at array index=Total Interactions in step 434. In the example, the user interacted while in the alteration mode using the mouse to perform a left double-click while the cursor was over a location that on an entity identified by ID 3332435 but not a snap point on that entity which location is identified by coordinates 4.75, 13.7 and did not pause or drag the mouse or press a key during the interaction. Thus, the Interaction Details array at index two, as shown in step 436, contains the following data: Interaction Type=Double Click (4096); Pick Point=4.75, 13.7; Mouse Button Pressed=Left (16); Key Pressed During Pick=None; Mouse Down Entity ID=3332435; Mouse up Entity ID=3332435; Dragged Mouse=False; Drag Type=None; Mouse Down Snap Point=Nearest Entity; Mouse up Snap Point=Nearest Entity; Nearest Point on Entity=4.75, 13.7; Pick Point on End Point=False; Entity ID List=3332435; Pre-Pick Text Value=Null; Paused on Mouse Down=False; Paused on Mouse up=False; Interaction Identifier=4112.

The system totals the values in the Interactions Details Array's interaction identifier data in accordance with FIG. 11 and stores the total in the Interactions Total variable in step 438. The system then searches the Interactions table for a record whose mode field matches the mode in which the current interaction was performed, illustratively the alteration mode, and includes the same Interaction ID value as the current interaction, illustratively 6176 (i.e. Interaction Identifier (First Index (2064))+Interaction Identifier (Second Index (4112))), in step 440. Illustratively a matching record is found which record includes “Extend” in its action field in step 442. Once the TIPR determines that the user wants to extend an object to another object, it calls the Extend function, which is the code that determines the values that need to be passed to the Extend command, and then executes the Extend command. The Extend function includes a first step 444. Step 444 includes using the Mouse down Entity ID data element value of the Interactions Detail Array at the first index to retrieve the entity to be extended. In step 446 it is determined if the retrieved entity is a line or an arc. Since only lines and arcs can be extended using the Extend command, if it is determined in step 446 that the entity is not a line or an arc, then in step 448 the user is alerted that they can only extend lines or arcs and the system proceeds to step 452. If in step 446 it is determined that the entity is a line or an arc, then the second step 450 of the extend function is performed. In step 450, the Extend command is executed using the Mouse Down Entity ID data element value at the first index of the Interactions Detail Array as the entity to extend, the Mouse Down Entity ID data element value at the second index of the Interactions Detail Array as the entity to extend to and the Pick point data element value at the first index of the Interactions Details array as the Pick Point. After passing the appropriate parameters and executing the Extend command in step 450 the system the performs step 452 wherein the system resets the system variables, erases the Interaction Details Array, sets the Total Interactions Variable to zero and sets the Current Mode to Alteration.

In summary, the Task Interaction Pattern Recognition process includes the steps of determining which task mode the user is operating in, determining how many interactions have occurred since the last function was executed, determining what types (Click, Double-Click, ClicknPause, Keypress, etc.) of interaction took place and in the case of mouse actions, which mouse button was used to invoke the action and determining where on the screen or object the interaction took place.

The disclosed user interface and method utilize Task Interaction Pattern Recognition technology to help to determine which drawing or editing command the user wants to perform while working in a particular Task Mode. The system continually monitors all mouse and/or keyboard actions executed by the user while in a designated task mode attempting to match the user interaction pattern to predefined user interaction patterns in order to execute the desired command. Mouse and/or keyboard output from the interaction is typically used as input parameters normally required by the command the user is attempting to execute.

One embodiment of the disclosed user interface is implemented using the functions and commands available in AutoCAD® a product of Autodesk, Incorporated. The manner in which AutoCAD® and various other CAD or graphics editor programs were utilized was analyzed and it was determined that five task modes should be developed with which frequently utilized functions were associated. Thus, this embodiment of the user interface includes a Creation task mode, an Alteration task mode, a Transformation task mode, an Inquiry task mode and an Annotation task mode. Those skilled in the art will recognize that the interface could include fewer, more or alternative task modes within the scope of the disclosure.

The Creation task mode is the mode where functions of the software related to the creation of primitives (lines, arcs, circles, rectangles, ellipses, polylines, polygons, etc.) and various abstractions of these primitives are associated. Examples of such commands are the line, 3 point arc and center point circle functions. The user can also create a new object from two or more existing objects while in the Creation tack mode. These groups of objects behave as a single object and are commonly known as inserts or blocks.

The Alteration task mode is the mode where functions of the software more commonly referred to in the CAD industry as modification functions are associated. In the illustrated embodiment, the Alteration task mode includes functions used to alter existing objects, such as trimming, extending, breaking, dividing, filleting, chamfering, exploding, and mending objects. Examples of commands or functions associated with the Alteration task mode in the disclosed embodiment are the Trim, Extend and Break commands.

The Transformation task mode is the mode where functions of the software that allow the user to change (transform) the location or and/or to duplicate existing objects are associated. Such functions allow previously created objects to be moved, copied, stretched, mirrored, rotated, and scaled. Examples of commands or functions associated with the Transformation task mode in the disclosed embodiment are the Move, Copy, Rotate and Mirror commands.

The Annotation task mode is the mode where functions of the software used to add text-centric objects (annotations) are associated. These functions allow for the creation of text centric objects such as dimensions, notes, labels, tables, etc. Examples of commands associated with the Annotation task mode in the disclosed embodiment are the Text, Label and Horizontal Dimension commands.

The Inquiry task mode is the mode where functions of the software used to measure or inquire about object's properties are associated. Examples of commands associated with the Inquiry task mode in the disclosed embodiment are the Measure, Area and Perimeter commands.

In this embodiment, each of the above modes is invoked by a single keystroke or combination keystroke. Pressing the <CTRL> key is the mode invocation method utilized to invoke the Creation task mode. Pressing the <ALT> key is the mode invocation method utilized to invoke the Alteration task mode. Pressing the <SHIFT> key is the mode invocation method utilized to invoke the Transformation task mode. Pressing the <TAB> key is the mode invocation method utilized to invoke the Annotation task mode. Pressing the <CTRL-SHIFT> key combination is the mode invocation method utilized to invoke the Inquiry task mode.

i. The decision to use these keystrokes to invoke a task mode (except for the Inquiry task mode) was made for word association and ergonomic reasons. First, with regard to word association, the letters “C” and “R” found on the <CTRL> key are also found in the term Creation which is selected as the task mode with which creation functions are associated. Similarly the letters “A”, “L” and “T” found on the <ALT> key are also found in the term Alteration which is selected as the task mode with which functions for altering or modifying primitives are associated. The word association related to the mode invocation method keys for the other two task modes in this embodiment are less directly associated with the names of the two other task modes. The <SHIFT> key is utilized to invoke the Transformation task mode because the functions associated with the transformation task mode typically involve moving or changing the position of (i.e. shifting the position of) primitives or objects formed by primitives. The <TAB> key is utilized to implement the Annotation task mode, which may be viewed as “tabulation” task mode in order to form a word association with the mode invocation method key.

ii. Second, the keys utilized as mode invocation methods to invoke the various task modes are selected for ergonomic reasons. Each of the selected keys are in close proximity to each other and are commonly pressed utilizing the user's left hand thereby freeing the user's right hand to use the mouse to perform the interaction patterns established for the functions associated with each of the task modes.

iii. Those skilled in the art will recognize that when many CAD programs generate a depiction of a circle to be displayed, the displayed object includes a center point snap cursor on the circumference of the circle. In this example, the user input or “interaction pattern” that executes the Copy function while in the Transformation task mode involves two sequential user inputs. The user utilizes the mouse or other pointing device to move the cursor to a point within the circle. As the mouse passes over the circumference of the circle, a temporary point is drawn at the center point of the circle. As the user moves the mouse cursor over this point the center point snap cursor appears and the user single clicks over the point. The user then utilizes the mouse or other pointing device to move the cursor to the desired location where the circle will be copied to and double-clicks. Since the point the user single clicked was the center point of the circle, the point the user double-clicked represents the center point of the newly copied circle.

iv. When the system recognizes the interaction pattern as the interaction pattern associated with the Copy command, it invokes the command passing three parameters to the command. The three parameters are the selected circle as the object to copy (note: the center point that the user clicked on is linked to the circle), the coordinates of the circle center point as the ‘copy from’ point and the coordinates of the point the user double-clicked as the ‘Copy to’ point. From these parameters a data structure is created that generates a circle having a center point at the second point that has the same diameter as the copied circle.

v. Although the invention has been described in detail with reference to certain preferred or illustrative embodiments, variations and modifications exist within the scope and spirit of the invention as described and as defined in the claims

What is claimed is:

1. A method of generating and/or modifying a graphical object in a computer controlled video display system, comprising:
providing a program for generating graphical objects in a graphics window of a computer controlled video display in response to a plurality of functions that generate video output;
defining a plurality of task modes to be implemented by the program;
designating a predefined mode invocation method for each of the plurality of task modes whereby upon execution of one of the predefined mode invocation methods the task mode with which the predefined mode invocation method is designated is implemented by the program;
associating each of the plurality of functions with one of the plurality of task modes;
designating for each of the plurality of functions a predefined interaction pattern to act as mode dependent task identifier for executing the function of the provided program, each predefined interaction pattern including pointer device gestures input while the cursor is in the graphics window;
monitoring the output of the alpha-numeric device and pointer device to determine if the output of those devices corresponds to a mode invocation method and a predefined interaction pattern; and
executing one of the plurality of functions when the monitoring step determines that the output corresponds with the program implementing the task mode with which the function is associated and the mode dependent interaction pattern designated for the function.

2. The method of claim 1 further comprising analyzing the operation of the program to determine which of the plurality of functions are utilized in similar functionality and wherein each of the plurality of functions are associated with a task mode based at least in part upon results of the analyzing step.

3. The method of claim 1 further comprising identifying a plurality of the task modes with a word representative of types of operations performed by the program and wherein the predefined mode invocation command for each of the identified plurality of task modes is designated at least in part based on a word association with the word identifying the task mode.

4. The method of claim 3 wherein ergonomic factors are considered in selecting the predefined mode invocation command.

5. The method of claim 2 further comprising identifying a plurality of the task modes with a word representative of types of operations performed by the program and wherein the predefined mode invocation command for each of the identified plurality of task modes is designated at least in part based on a word association with the word identifying the task mode.

6. The method of claim 5 wherein ergonomic factors are considered in selecting the predefined mode invocation command.

7. The method of claim 1 wherein interactions with the pointer device and alpha numeric device are monitored and data regarding the interactions is stored.

8. The method of claim 7 wherein each interaction with the pointer device or alpha numeric device is assigned a value that is a power of two.

9. The method of claim 8 wherein the monitored output of the alpha-numeric device and pointer device is stored as binary number data.

10. The method of claim 9 wherein the mode dependent interaction pattern designated for each function is stored in memory as a binary number and the further comprising a comparison step wherein a bitwise comparison is performed between the binary number data relating to the monitored output of the alpha-numeric device and the binary number data stored with regard to at least one mode dependent interaction pattern.

11. A method of generating images utilizing a drawing editor having a plurality of functions that manipulate data from which the screen display is generated, the method comprising:
designating a plurality of task modes;
associating each function that manipulates data with one of the designated task modes;
designating a mode invocation method for invoking each of the plurality of task modes;
designating a task mode sensitive distinct interaction pattern with each function.

12. The method of claim 11 wherein each distinct interaction pattern comprises a series of distinct pointer controller device operations.

13. The method of claim 12 wherein each mode invocation method comprises input from the keyboard.

14. The method of claim 13 further comprising monitoring user interactions and comparing the monitored interaction to the distinct interaction patterns to determine if a distinct interaction pattern has been performed.

15. The method of claim 14 further comprising executing the function associated with a distinct interaction pattern when it is determined in the comparing step that the distinct interaction pattern has been performed by the user.

16. An apparatus for executing commands from a graphics editor comprises:
computer system including a bus for communicating information, a processor coupled with the bus for processing information, and memory coupled to the bus for storing information and instructions for processor a display device coupled to the bus for displaying information to the computer user including a cursor, an alpha-numeric input device including alpha numeric and other keys coupled to the bus, and a cursor control device for communicating direction information and command selections to the processor and for controlling the cursor movement; and
graphic editor software resident in the memory having functions for generating and manipulating objects represented by addressable data structures stored in memory from which the processor generates video output for generating a graphical display of the object on the display device, the software including user selectable task modes with which each of the plurality of functions is associated, each function being executed upon entry of an interaction pattern including cursor control device gestures input while the cursor is in the graphics window while the program is in the task mode with which the function is associated.
